(19) United States
(12) Patent Application Publication
(10) Pub. No.: US 2023/0300054 A1
(43) Pub. Date: Sep. 21, 2023

(54) DYNAMIC DEVICE CLUSTERING SYSTEM AND METHOD

(71) Applicant: MERSIVE TECHNOLOGIES, INC., Denver, CO (US)

(72) Inventors: Christopher O. JAYNES, Denver, CO (US); Vincent FERRERI, Denver, CO (US); Jamie LONGENECKER, Denver, CO (US)

(21) Appl. No.: 18/041,469

(22) PCT Filed: Aug. 14, 2021
(86) PCT No.: PCT/US2021/046053

§ 371 Date: Feb. 13, 2023

Related U.S. Application Data
(60) Provisional application No. 63/065,584, filed on Aug. 14, 2020.

(51) Int. Cl. H04L 43/50

(52) U.S. Cl. CPC H04L 43/50

(57) ABSTRACT

A method and apparatus forms clusters of co-located devices by correlating measurable quantities that are observed by the devices. Devices, both fixed and mobile, may be clustered according to spatially defined locations by receiving a plurality of observations of measurable metrics from the devices; scoring the plurality of observations to define a cluster state at each of the spatially defined locations, wherein the cluster state comprises a plurality of measurable quantities; assigning the devices to a cluster of a plurality of clusters; after assigning the devices to the cluster, receiving additional observations of measurable metrics from the devices; and autonomously updating the cluster states in based on the additional observations.

### CROSS-REFERENCE TO RELATED APPLICATION

This application claims priority to and benefits from United States Provisional Application Serial No. 63/065,584 filed Aug. 14, 2020, the entirety of which is incorporated by reference herein.

### BACKGROUND

The present disclosure relates generally to video conferencing systems and methods, and more specifically to clustering related devices to allow for data and characteristics to be shared across devices.

Digital infrastructure serves to connect computing devices for communication and sharing in a multitude of ways. Digital infrastructure may include computing devices such as mobile phones, laptops and servers and the applications and software that they execute, as well as the networks to which they are connected. Communication and sharing include may transferring content between users such as text, audio, video, images, documents, or any type of content that may be created or represented on a digital device. Users and their computing devices may be located in the same room or in far-flung geographic locations.

In office settings, part of the digital infrastructure may include one or more conference rooms configured with video conferencing systems. These systems allow users to leverage the conference room to share digital content in a collaborative way with other participants in the same room and/or in remote locations. A physical office space occupied by a business or organization may include more than one conference room, each of which may be outfitted with a video conferencing system. Video conferencing systems in conference rooms are typically coupled to a local network maintained in the physical office space but may also be connected to the Internet directly.

Many computing devices are connected to a global digital infrastructure permanently or as a background process, such as a cellular or Wi-Fi® network. In other cases, users may need to make an intentional decision to connect a user device to digital infrastructure such as a video conferencing system or a networked printer. This decision may require selecting from several options since a business or organization may encompass two or more physical office spaces, each with their own digital infrastructure including video conferencing systems, printers, servers and other digital devices. Connecting a user device to digital infrastructure can be made easier by an understanding of the geospatial arrangement of both the user device and the digital infrastructure i.e., understanding which physical office space in which the user device is located.

### SUMMARY

In an embodiment, a computer-implemented method of clustering devices according to spatially defined locations includes receiving a plurality of observations of measurable metrics from the devices; scoring the plurality of observations to define a cluster state at each of the spatially defined locations, wherein the cluster state comprises a plurality of measurable quantities; assigning the devices to a cluster of a plurality of clusters; after assigning the devices to the cluster, receiving additional observations of measurable metrics from the devices; and autonomously updating the cluster states in based on the additional observations.

In embodiments, a system of host computers maintained by a business to provide video conference rooms receives observations from fixed and mobile devices to form clusters of co-located devices by correlating measurable quantities that are observed by the devices.

### BRIEF DESCRIPTION OF THE FIGURES

The foregoing and other features and advantages of the disclosure will be apparent from the more particular description of the embodiments, as illustrated in the accompanying drawings, in which like reference characters refer to the same parts throughout the different figures. The drawings are not necessarily to scale, emphasis instead being placed upon illustrating the principles of the disclosure.

FIG. 1 illustrates an occupancy determiner that cooperates with a mobile device to determine occupancy of the mobile device in a single room, in embodiments.

FIG. 2 illustrates one example of an occupancy determiner that cooperates with the mobile device to determine occupancy of the mobile device in the room, in embodiments.

FIG. 3 is a functional diagram of one example system that determines occupancy of the mobile device in a room, in embodiments.

FIG. 4 illustrates a room layout showing first and second systems of FIG. 3 located in first and second rooms, respectively, in embodiments.

FIG. 5 illustrates one example of a method that determines occupancy of a mobile device in a room, in embodiments.

FIG. 6 illustrates one example of a method that trains a classifier used to determine room occupancy, in embodiments.

FIG. 7 illustrates one example of a method that determines occupancy of a mobile device in a room, in embodiments.

FIG. 8 illustrates one example of a method that determines occupancy of a mobile device in a room, in embodiments.

FIG. 9 illustrates a set of clusters with spatially defined locations, in embodiments.

FIG. 10 illustrates a flowchart of a method of clustering devices according to spatially defined locations, in embodiments.

FIG. 11 illustrates an example of several office spaces for use in identifying clusters of devices, in embodiments.

### DETAILED DESCRIPTION OF THE EMBODIMENTS

A business or organization typically occupies a physical office space that may include a number of sub-spaces such as individual offices, conference rooms, reception areas and workrooms. In office settings, digital infrastructure may include local networks such as a WAN or LAN, for connecting user devices and other infrastructure, such as printers and video conferencing systems. These networks may provide connectivity within one office, between multiple offices, or to the Internet in general. An office space at a spatially defined location may include several conference rooms, each with a video conferencing system. In addition, employees or members of the organization may be able to host or participate in a video conference from a user device in an individual office. Video conferencing systems in conference rooms are typically coupled to a local network maintained in the physical office space but may also be connected to the Internet directly. Video conferencing systems typically include a host computer that controls a room display and possibly a camera, microphone or other video conferencing devices. User’s may connect a user device to the host computer to participate in the video conference and share digital content.

Businesses and organizations may have multiple physical offices in locations that are geographically separated. Some may have several different physical offices in a single country, or offices in multiple countries. For ease of description, the term “business” will be used herein to represent any entity or organization that provides and maintains a digital infrastructure.

Businesses may own and maintain a large variety of digital infrastructure, including video conferencing systems, printers, routers and other networking devices. They may also provide user devices such as laptops and mobile devices for their employees. When a business provides a user device for a user, it is commonly understood that certain applications and control features are installed on the user devices for use by an administrator or IT department to meet the needs of the business or organization. These types of applications will also be installed on other pieces of digital infrastructure for maintenance and control.

In summary, a business maintains a set of digital devices, some of them fixed and some mobile, that are capable of making observations about their environment and sharing them with an administrator using an application on the digital device. For some devices, these observations may include GPS signals, cellular network signals, electromagnetic radiation, and atmospheric conditions, for example, although other types of observations are contemplated. Observations may have measured signal characteristics including average power, frequency response (e.g., Fourier coefficients), or ratios of Fourier coefficients.

These observations can by correlated to define cluster states associated with spatially defined locations such as physical office spaces. Individual devices can be assigned to clusters based on the correlation between their observations and one or more cluster states. Observations may be processed in a variety of ways, including neural networks and clustering algorithms.

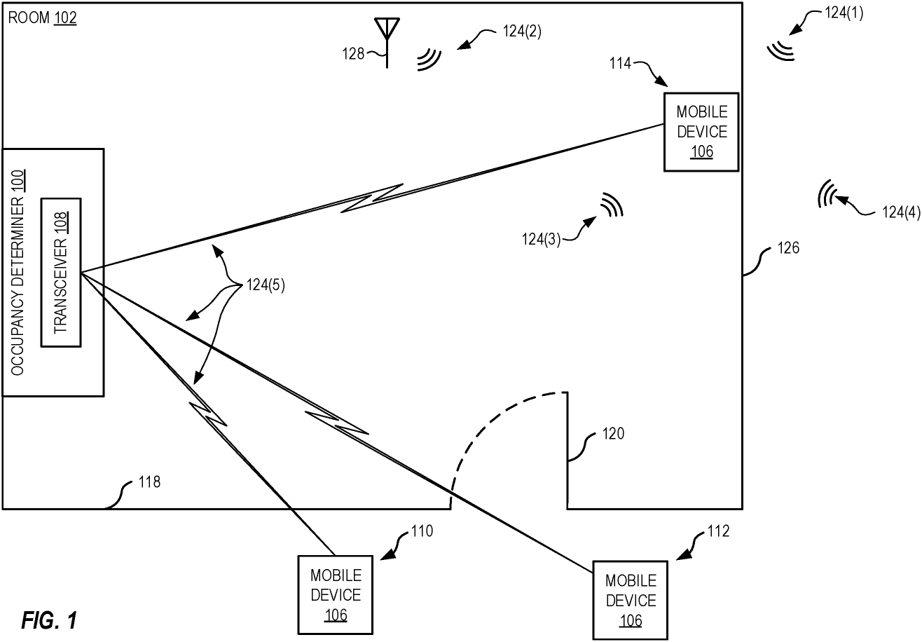

FIGS. 1 - 8 show apparatus and methods for using observations of wireless signals to identify a geospatial location of a device and proximity of one device to another.

FIG. 1 shows an occupancy determiner 100 that cooperates with a mobile device 106 to determine occupancy of the mobile device 106 in a room 102. In embodiments, occupancy determiner 100 may be an example of a host computer of a video conferencing system. The mobile device 106 detects and measures a plurality of wireless signals 124, some of which may originate within the room 102 (e.g., wireless signals 124(2) and 124(3)), and some of which may originate from outside of the room 102 (e.g., wireless signals 124(1) and 124(4)). While FIG. 1 shows the mobile device 106 measuring four wireless signals 124, the mobile device 106 may measure any number of wireless signals 124 without departing from the scope hereof.

With each of the wireless signals 124, the mobile device 106 measures one or more wireless-signal characteristics and a wireless-signal identifier. Examples of the wireless-signal characteristics include an average power, one or more Fourier coefficients of a spectrum of the received wireless signal, and one or more ratios of the Fourier coefficients. The wireless-signal identifier uniquely identifies each of the wireless signals 124, and may be, for example, a Wi-Fi secure set identifier (SSID), a MAC address and/or IP address of an emitter that transmitted the corresponding wireless signal 124, or a universal unique identifier (UUID).

The one or more wireless-signal parameters include values that characterize one of the wireless signals 124, as received by the mobile device 106. The wireless-signal parameters for all the measured wireless signals 124 form a signature unique to the room 102. That is, if the mobile device 106 were to measure the same wireless signals 124 in a different room, the mobile device 106 would obtain different wireless-signal parameters. Thus, the occupancy determiner 100 can use the wireless-signal parameters to differentiate between whether the mobile device 106 is in the room 102 and out of the room 102.

The mobile device 106 transmits the wireless-signal identifiers and corresponding measured wireless-signal characteristics of the measured wireless signals 124 to the occupancy determiner 100 via a transceiver 108. The occupancy determiner 100 then processes the received wireless-signal characteristics to determine the occupancy of the mobile device 106 in the room 102. In FIG. 1, the mobile device 106 is shown communicating wirelessly with the occupancy determiner 100 (e.g., Wi-Fi, ZigBee, cellular). Alternatively, the mobile device 106 may communicate with the occupancy determiner 100 via a wired connection (e.g., Ethernet, USB).

In FIG. 1, where the occupancy determiner 100 is physically located in the room 102 and includes a wireless transceiver 108, a wireless signal 124(5) emitted by the transceiver 108 may be measured by the mobile device 106 as one of the wireless signals 124. However, it is not necessary for the occupancy determiner 100 to operate wirelessly; the mobile device 106 can measure wireless signals 124 emitted from other devices. In some embodiments, the occupancy determiner 100 is not physically located in the room 102 yet still communicable with the mobile device 106 (e.g., via a local-area network or a wide-area network).

FIG. 1 shows the mobile device 106 at three positions where the mobile device 106 will measure different wireless-signal characteristics for the wireless signal 124(5). At a position 110, the mobile device 106 is in a hallway outside of the room 102. At a position 112, the mobile device 106 is in the hallway outside of the room 102, but close to a door 120 of the room 102. At a position 114, the mobile device 106 is in the room 102. As shown in FIG. 1, various obstacles may alter the wireless signals 124, and thus how the mobile device 106 measures the corresponding wireless-signal characteristics. For example, at the position 110, the mobile device 106 receives the wireless signal 124(5) as altered by a wall 118. At the position 112, when the door 120 is open, the mobile device 106 receives the wireless signal 124(5) without any interfering obstacle, even though the mobile device 106 is outside of the room 102. At the position 114, the mobile device 106 also receives the wireless signal 124(5) unaltered by any intervening obstacle.

Since the positions 112 and 114 are equidistant from the transceiver 108 and have direct line-of-sight to the transceiver 108, the mobile device 106 may measure similar wireless-signal characteristics for the wireless signal 124(5) at these two positions. In this case, the mobile device 106 may measure wireless-signal characteristics of other wireless signals (e.g., the wireless signals 124(1), 124(2), 124(3), and 124(4)) to further differentiate between the positions 112 and 114. For example, the wireless signal 124(2) may be transmitted by an antenna 128 located in the room 102 elsewhere from the transceiver 108 such that the positions 112 and 114 are not equidistant from the antenna 128. In this case, the mobile device 106 may measure a different power of the wireless signal 124(2) at the position 112, as compared to the position 114. Thus, the measured power of the wireless signal 124(2) can help distinguish between the positions 112 and 114.

In another example shown in FIG. 1, the wireless signal 124(1) originates outside of the room 102 and may be detected at the position 114 after propagating through one wall 126. However, to reach the position 112, the wireless signal 124(1) must propagate through two walls (i.e., the wall 126 and the wall 118). Due to the different number of intervening walls, the mobile device 106 may measure a higher power of the wireless signal 124(1) at the position 114, as compared to the position 112. Thus, the measured power of the wireless signal 124(1) may help distinguish between the positions 112 and 114.

It should be appreciated from the above discussion that a variety of additional factors will likely affect the wireless-signal characteristics measured by the mobile device 106. For example, the gain, directivity, and orientation of an antenna (e.g., the antenna 128) determines propagation of a wireless signal transmitted therefrom, and thus the corresponding wireless-signal characteristics measured by the mobile device 106 will depend upon the location of the mobile device 106 relative to the antenna and its propagation pattern. Other factors include reflections off, and absorption within, various obstacles and walls; these factors may in turn depend upon orientation, thickness, and material properties (e.g., permittivity and absorptivity) of the materials forming the obstacles. Many of these factors, such as absorptivity, also depend upon the frequency of the wireless signal.

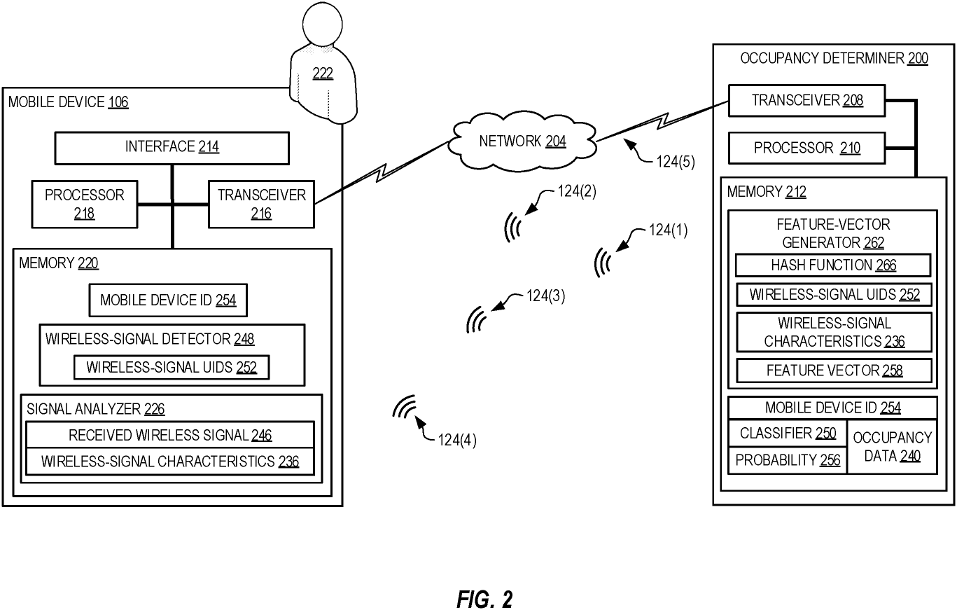

FIG. 2 shows one example of an occupancy determiner 200 that cooperates with the mobile device 106 to determine occupancy of the mobile device 106 in the room 102. The occupancy determiner 200 is one example of the occupancy determiner 100 of FIG. 1. The occupancy determiner 200 includes a processor 210, a transceiver 208, and a memory 212 that are communicatively coupled to each other (e.g., via a bus). Similarly, the mobile device 106 includes a mobile processor 218, a mobile transceiver 216, an interface 214, and a mobile memory 220 that are communicatively coupled to each other. The memory 212 and the mobile memory 220 store data and machine-readable instructions that implement functionality described herein. The transceiver 208 is one example of the transceiver 108 of FIG. 1.

The mobile device 106 includes a wireless-signal detector 248 implemented as machine-readable instructions that are stored in the mobile memory 220 and configured to control the mobile processor 218 to detect wireless signals 124 with the mobile transceiver 216, and store in the mobile memory 220 a list of wireless-signal unique identifiers (UIDs) 252 that identify the detected wireless signals 124. For example, when the mobile device 106 is configured to operate wirelessly via Wi-Fi, the wireless-signal detector 248 may create a list of SSIDs obtained from the detected wireless signals 124. The wireless-signal detector 248 may also use for the wireless-signal UIDs IP addresses, MAC addresses, and/or other identifying information obtainable from the wireless signals 124.

The mobile device 106 also includes a signal analyzer 226 implemented as machine-readable instructions that are stored in the mobile memory 220 and configured to control the mobile processor 218 to receive one of the wireless signals 124, via the mobile transmitter 216, as a received wireless signal 246 stored in the memory 220. The signal analyzer 226 then processes the received wireless signal 246 to obtain one or more wireless-signal characteristics 236. For example, the signal analyzer 226 may implement a Fourier transform that computes a frequency spectrum of the received wireless signal 246 and stores one or more Fourier coefficients of the frequency spectrum as the wireless-signal characteristics 236. The mobile device 106 then transmits the wireless-signal characteristics 236 and a corresponding wireless-signal UID 252 to the occupancy determiner 200 via the network 204. The mobile device 106 may also transmit with the wireless-signal characteristics 236 a mobile device identifier 254 so that the occupancy determiner 200 can differentiate between the wireless-signal characteristics 236 measured with the mobile device 106, and wireless-signal characteristics measured with other devices.

The occupancy determiner 200 determines occupancy of the mobile device 106 using a classifier 250 that calculates from the received wireless-signal characteristics 236 an occupancy probability 256 that the mobile device 106 is in the room 102. The occupancy determiner 200 may then store the occupancy probability 256 in the memory 212 as occupancy data 240. Furthermore, the occupancy determiner 200 may store the mobile device identifier 254 with the occupancy probability 256 in the occupancy data 240 to track the occupancy of the mobile device 106. Thus, the occupancy data 240 is a register of all mobile devices interacting with the occupancy determiner 200. As such, the occupancy data 240 not only stores binary occupancy of the room (i.e., whether the room is occupied or not), but also the number of mobile devices therein.

In the following discussion, the classifier 250 is presented as an artificial neural network (ANN) having a plurality of input nodes and one output node. However, the classifier 250 may be implemented with another type of classification algorithm (e.g., binary classification tree, random forest, support vector machine) without departing from the scope hereof. When implemented as an ANN, the classifier 250 may have any number of layers, any number of nodes in any of the layers, and any type of artificial neuron function (e.g., ReLU, softmax, etc.) known in the art. The layers may be connected via any type of architecture, such as fully-connected, sparsely-connected, and recursive.

To input the wireless-signal characteristics 236 into the classifier 250, the occupancy determiner 200 includes a feature-vector generator 262 implemented as machine-readable instructions that are stored in the memory 212 and configured to control the processor 210 to arrange the wireless-signal characteristics 236 into a feature vector 258 that is subsequently inputted to the classifier 250. When the classifier 250 is an ANN, each element of the feature vector 258 may correspond to a unique input node of the ANN that receives one wireless-signal characteristic (e.g., a single value of power, a single real Fourier coefficient) of one wireless signal 124. To ensure that the same one wireless-signal characteristic of the one wireless signal 124 is always inputted to the same input node of the ANN, the feature-vector generator 262 may input the wireless-signal characteristics 236 into the feature vector 258 based on the corresponding wireless-signal UID 252. For example, the feature-vector generator 262 may map each wireless-signal UID to a unique index of the feature vector 258, and sequentially input the corresponding wireless-signal characteristics 236 to the feature vector 258 starting at the unique index. Neighboring indices returned by the mapping are spaced by the number of wireless-signal characteristics for a single wireless signal. For example, if there are five wireless-signal characteristics 236 for one wireless signal 124, and the mapping returns a starting index value of 6, the feature-vector generator 262 will input the five wireless-signal characteristics 236 into elements 6 through 10 of the feature vector 258. In this case, the mapping is prevented from returning each of index numbers 7 through 10 as a starting index.

In some embodiments, a hash function 266 maps each wireless-signal UID to a unique index of the feature vector 258. The feature-vector generator 262 may then enter the wireless-signal characteristics 236 sequentially into the feature vector 258 starting at the corresponding unique index. Thus, the hash function 266 ensures that the wireless-signal characteristics 236 obtained from one wireless signal 124 are always entered to the classifier 250 identically (i.e., into the same input nodes of the ANN) regardless of which mobile device measured the wireless-signal characteristics or when the wireless-signal characteristics were measured.

Advantageously, the hash function 266 allows input nodes of the ANN to be reused as new wireless signals 124 are detected in the room, and other wireless signals 124 are no longer detectable. To minimize hash collisions, the number of input nodes of the ANN is chosen to be large compared to the total number of wireless-signal characteristics expected. For example, if one wireless-signal characteristic is measured for one wireless signal (e.g., time-averaged power), then the total number of wireless-signal characteristics equals the number of wireless signals 124 detectable in the room. In this case, the number of input nodes (i.e., a length of the feature vector 258) may be chosen to be two orders of magnitude greater than an expected number of wireless signals 124 detectable in the room.

In some embodiments, usage of the hash function 266 is based on a type of the wireless signal 124 (e.g., Wi-Fi, Bluetooth, BLE). For example, Wi-Fi signals may be hashed to a first portion of the feature vector 258, while Bluetooth signals may be hashed to a remaining portion of the feature vector 258. In other embodiments, stable and/or reliable wireless signals (e.g., Wi-Fi access points, beacons, etc.) are “registered” by assigning to each of these stable signals a unique portion of the feature vector 258. These unique portions are excluded from the hash function 266, thereby preventing hash collisions with these stable signals. A remaining unregistered portion of the feature vector 258 may then be used for other wireless signals, such as Bluetooth signals that are only detectable when a Bluetooth device is in the room and powered on.

In one embodiment, the occupancy determiner 200 dynamically learns which wireless signals 124 in the room are stable and/or reliable, advantageously registering stable wireless signals automatically. For example, the occupancy determiner 200 may track usage of the wireless-signal UIDs 252 over time and register a wireless signal 124 whose usage is consistently high over extended periods (e.g., days or weeks). The occupancy determiner 200 may maintain this wireless signal 124 as registered while its usage remains high. When the usage falls, the occupancy determiner 200 may unregister the wireless signal 124 and assign the corresponding wireless-signal characteristics to a different portion of the feature vector 258.

The transceiver 208 and the network 204 may operate according to one or more wired and/or wireless data transmission protocols including, but not limited to, the Internet, a local intranet, a Personal Area Network, a Local Area Network, a Wide Area Network, a virtual private network, cellular connections (3G, 4G, 5G, NB-1, etc.), WAP (Wireless Application Protocol), General Packet Radio Service, (Global System for Mobile Communication, Code Division Multiple Access, Time Division Multiple Access, Frequency Division Multiple Access, and/or Orthogonal Frequency Division Multiple Access, GPS, cellular digital packet data, Bluetooth, Z-wave protocol, an IEEE 802.11-based radio frequency network, or any other wired or wireless digital communication protocol.

The processor 210 is one or more computing devices configured to execute computer-readable instructions stored in the memory 212 to implement the functionality of the occupancy determiner 200 discussed herein. The memory 212 may include operating memory, such as random-access memory (RAM), as well as data storage, such as read-only memory (ROM), hard drives, flash memory, or any other suitable memory/storage element. The memory 212 may include internal or external memory elements, such as USB drives, Secure Digital card, magnetic, optical, and/or semiconductor memory.

The mobile device 106 may be a tablet, laptop computer, smartphone, or any other portable device. The interface 214 is a component of the mobile device 106 through which a user 222 interacts. For example, the interface 214 may be a display screen, a mouse, keyboard, a touchscreen of a mobile device, tablet, computer, etc. The mobile transceiver 216 is similar to transceivers 108 and 208 and may be any device capable of transmitting and/or receiving digital communications via network 204. The mobile processor 218 may be one or more computing devices configured to execute machine-readable instructions stored in the mobile memory 220 to implement the functionality of the mobile device 106 discussed herein. The mobile memory 220 may include operating memory, such as random-access memory (RAM), as well as data storage, such as read-only memory (ROM), hard drives, flash memory, or any other suitable memory/storage element. The mobile memory 220 may include removable memory elements, such as a CompactFlash card, a MultiMediaCard (MMC), and/or a Secure Digital (SD) card.

### Training the Classifier

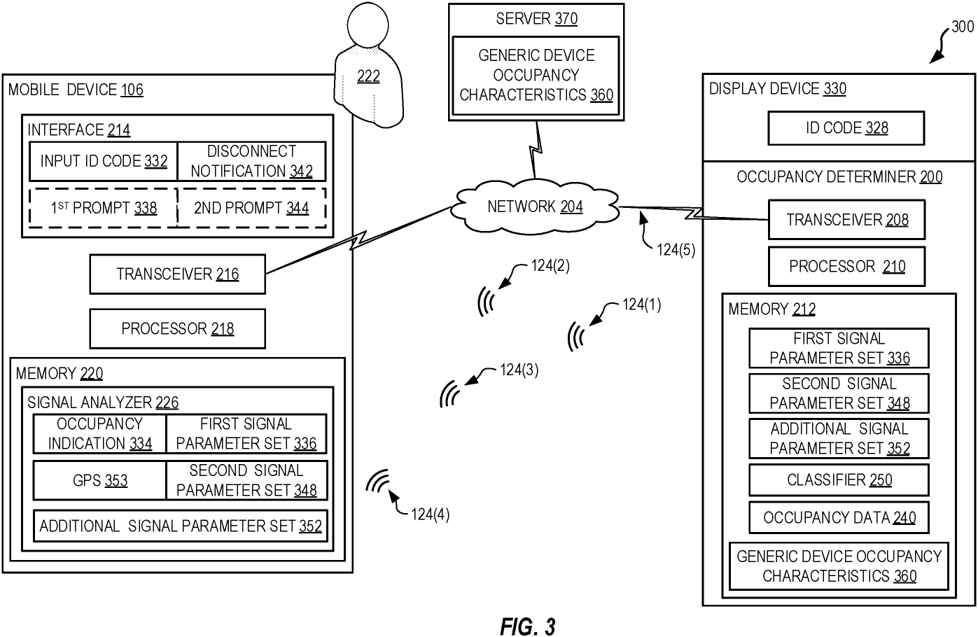

FIG. 3 is a functional diagram of one example system 300 that determines occupancy of the mobile device 106 in a room (e.g., the room 102 of FIG. 1). The system 300 includes the occupancy determiner 200 of FIG. 2, further configured with additional and/or alternative data and machine-readable instructions stored in the memory 212. Similarly, FIG. 3 shows the system 300 operating with the mobile device 106 of FIGS. 1-2, further configured with additional and/or alternative data and machine-readable instructions stored in the mobile memory 220. In FIG. 3, both the mobile device 106 and the occupancy indicator 200 are shown storing a first signal parameter set 336, a second signal parameter set 348, and at least one additional signal parameter set 352. Each of these signal parameter sets is one example of the wireless-signal characteristics 236 of FIG. 2.

The occupancy indictor 200 implements the classifier 250 as data and/or machine-readable instructions that are stored in the memory 212 and configured to control the processor 210 to predict the occupancy of the mobile device 106 using any of the signal parameter sets received from the mobile device 106. The classifier 250 may be represented as a mathematical function f that receives a parameter set X and returns an occupancy probability y (e.g., the occupancy probability 256 of FIG. 2) that the mobile device 106 in the room, i.e., y = f(X). In this case, the classifier 250 is a binary classifier. The occupancy determiner 200 may then store the occupancy probability y in the occupancy data 240.

Each time the mobile device 106 receives one or more wireless occupancy signals 124, the signal analyzer 226 processes the received wireless occupancy signals 124 to update one of the signal parameter sets 336, 348, and 352. The mobile device 106 then transmits the updated signal parameter set to the occupancy determiner 200 via the network 204. The occupancy determiner 200 inputs the updated signal parameter set to the classifier 250 to update the occupancy probability y and the occupancy data 240. Thus, the system 300 works with the mobile device 106 to repeatedly update its prediction that the mobile device 106 is in the room.

In addition to predicting the occupancy of the mobile device 106 in the room, the occupancy determiner 200 includes additional machine-readable instructions (e.g., stored in the memory 212) that train the classifier 250 with training examples. Each training example may have the form (X, 0), where 0 is a binary variable indicating the known occupancy. For example, 0 = 1 may indicate that the mobile device 106 is in the room, and 0 = 0 may indicate that the mobile device 106 is not in the room. Each training example may be used to train the classifier 250 by minimizing a cost function with backpropagation, stochastic gradient descent, or another training algorithm known in the art.

Thus, the system 300 cooperates with the mobile device 106 to both train the classifier 250 and use the classifier 250 for predicting. In the following discussion, examples are given of how the system 300 may obtain training examples for training the classifier 250. As will be appreciated by those trained in the art, the accuracy of the predictions generated by the classifier 250 depends on how well the classifier 250 has been trained, i.e., how many training examples were used. Thus, the following examples are important for generating a significant number of training examples, as needed to ensure that the classifier 250, after training, predicts occupancy with sufficient accuracy.

A training example may be generated when the mobile device 106 receives a wireless signal 124 upon entering the room. A unique ID code 328 may be assigned to the occupancy determiner 200. In situations where there is a plurality of rooms that each have an associated occupancy determiner 200, each occupancy determiner 200 may be assigned a corresponding unique ID code 328. The unique ID code 328 is communicated to the mobile device 106 via audio, visual, optical and/or wireless means. For example, in FIG. 3 the unique ID code 328 may be displayed on a display device 330 that is integrated with the occupancy determiner 200 (e.g., a “smart display”) or that is an off-the-shelf display that connects to a “pod” (e.g., the Solstice pod by Mersive Technologies Inc.) or another device configured to perform the functionality of the occupancy determiner 200. In embodiments, display device 330 and occupancy determiner 200 may be part of a video conferencing system. Upon entry to the room, the user 222 visually reads the unique ID code 328 from the display device 330 and enters the unique ID code 328 to the mobile device 106 via the interface 214. In another example, the unique ID code 328 is audibly played through speakers within the room and a microphone of the mobile device 106 (not shown in FIG. 1) records the audible sound to receive the unique ID code 328. In another example, the mobile device 106 wirelessly receives the unique ID code 328, for example, through infrared/optical transmission, SMS transmission or another means of data communication. In another example, the mobile device 106 includes a camera that scans the unique ID code 328 from the display device 330 in the form of a QR code, bar code, numerical code, or the like.

Upon receiving the unique ID code 328, the mobile device 106 stores the unique ID code as an input ID code 332, and the signal analyzer 226 sets an occupancy indication 334 in the mobile memory 220 to TRUE. When set to TRUE, the occupancy indication 334 indicates that the mobile device 106 is known to be in the room, i.e.., the occupancy indication is a positive occupancy indication. Similarly, when set to FALSE, the occupancy indication 334 indicates that the mobile device 106 is known to be out of the room, i.e., the occupancy indication 334 is a negative occupancy indication. In embodiments where the user 222 interacts with the interface 214 to input the unique ID code 328, the occupancy indication 334 is automatically verified due to the actions of the user 222 (assuming the user 222 correctly entered the unique ID code 328). In embodiments where the unique ID code 328 is obtained without interaction by the user 222, the user 222 may be prompted (e.g., with a first prompt 338 displayed on the interface 214) requesting verification that the mobile device 106 is in the room; the response to the first prompt 338 entered by the user 222 verifies if the mobile device 106 is in the room or not.

After receiving the unique ID code 328, the mobile device 106 receives at least one wireless signal 124 (e.g., as the received occupancy signal 246). The signal analyzer 226 then processes the received wireless signal 124 to generate the first signal parameter set 336. The mobile device 106 then transmits the occupancy indication 334, the input ID code 332, and the first signal parameter set 336 to the occupancy determiner 302 via the network 204. Upon receiving this data from the mobile device 106, the occupancy determiner 200 compares the received ID code 332 to its unique ID code 328. If the two ID codes match, the occupancy determiner 200 stores the received occupancy indication 334 and the first signal parameter set 336 in the memory 212. The occupancy determiner 200 may then form one training example from the first signal parameter set 336 (i.e., X) and occupancy indication 334 (i.e., 0 = 1), and train the classifier 250 with the one training example. Furthermore, since the mobile device 106 is known to be physically located in the room, the occupancy determiner 200 may also update the occupancy data 240 accordingly.

When the two ID codes do not match, the occupancy determiner 200 has received data intended for a different occupancy determiner, in which case the occupancy determiner 200 may either ignore the received occupancy indication 334 and first signal parameter set 336, or forward the received occupancy indication 334 and first signal parameter set 336 via the network 204 to the intended occupancy determiner. Furthermore, the occupancy 200 may train the train the classifier 250 with the unintended first signal parameter set 336 and a negative occupancy indication, as the mismatch of ID codes verifies that the unintended first signal parameter set 336 was generated by a mobile device in another room.

Advantageously, interaction with the interface 214 (e.g., by the user 222) eliminates the need for additional hardware and leverages existing hardware, such as smart displays and devices (e.g., the Solstice pod by Mersive Technologies Inc.). Furthermore, the occupancy determiner 200 can determine the exact number of mobile devices within the room but does not require prior knowledge of the room size. In other words, the interaction with interface 214 does not require entry of the room size or shape characteristics to determine occupancy within the associated room.

The occupancy determiner 200 may also be configured to identify when the mobile device 106 is out of the room, in which case another training example may be generated when the mobile device 106 leaves the room. For example, when the user 222 leaves the room, the user 222 may interact with the interface 214 to generate a disconnect notification 342. The disconnect notification 342 may be generated manually when the user 222 interacts with the interface 214. In embodiments, the disconnect notification 342 may be generated in response to a second prompt 344. For example, the interface 214 may periodically generate the second prompt 344 saying “are you still in the room?” Furthermore, the disconnect notification 342 may be generated automatically, such as via the interface 214 receiving an electronic trigger from an electronic device (such as an RFID transmitter, an optical IR transmitter, etc.) when the user 222 leaves the room.

Upon receipt of the disconnect notification 342, the signal analyzer 226 may set the occupancy indication 334 to FALSE. The mobile device 106 may then receive a wireless signal 124 (e.g., update the received occupancy signal 246 in FIG. 2). The signal analyzer 226 then processes the received wireless signal 124 to generate the second signal parameter set 348. The mobile device 106 transmits the negative occupancy indication 334, the input ID code 332, and the second signal parameter set 348 to the occupancy determiner 200 via the network 204. Upon receiving this data from the mobile device 106, the occupancy determiner 200 compares the received ID code 332 to its unique ID code 328. If the two ID codes match, the occupancy determiner 200 then forms from the received occupancy indication 334 and the second signal parameter set 348 one training example that is used to train the classifier 250. Furthermore, since the mobile device 106 is known to be physically leaving the room, the occupancy determiner 200 may also update the occupancy data 240 accordingly.

Additional training examples may be generated every time that the mobile device 106 generates the second prompt 344 to determine if the user 222 is still in the room. Specifically, when the user 222 responds to the second prompt 344 by indicating that he or she is still in the room, the occupancy of the user 222 is known with certainty (i.e. occupancy indication 334 is equal to TRUE) and thus may serve as a supervisory signal for producing one training example. Signal analyzer 226 may then update the additional signal parameter set 352 based on a new measurement of at least one wireless signal 124, and transmit the updated additional signal parameter set 352 and the occupancy indication 334 (i.e., TRUE) to the occupancy determiner 200 for training the classifier 250 and updating the occupancy data 240.

It should be appreciated from the above discussion that a training example can be generated every time that (a) the mobile device 106 updates any of the signal parameter sets 336, 348, and 352 from a new measurement of at least one wireless signal 124, and (b) the occupancy of the mobile device 106 is known with certainty. For example, when the occupancy determiner 200 receives an in-room training example (i.e., 0 = 1) with an input ID code 332 that does not match the unique ID code 328, then the occupancy determiner 200 has received a training example intended for a different occupancy determiner. In this case, the occupancy determiner 200 may assume that the mobile device that sent the communication is in a different room, and thus may train classifier 250 with the received parameter set and a supervisory signal 0 = 0.

Each of the signal parameter sets 336, 348, and 352, may be represented as a single value, a one-dimensional vector of values, a two-dimensional matrix of values, or any other data structure sufficiently sized and configured to store the signal parameter set. For example, the signal parameter set may be represented as a vector X = (P₁, P₂, P₃, ..., P_{N}), where N is the number of signal parameters, and each element P is one parameter of one measured wireless signal 124. The signal parameters may be Fourier coefficients of the measured wireless signal 124. As another example, a single parameter P represents an average signal strength of the wireless signal 124 over a short period of time. The signal parameter set may also be one or more ratios between strengths of signal components (e.g., amplitudes of Fourier coefficients) of the received wireless signal 124, or one or more ratios between strengths of signal components of the received wireless signal 124. The signal parameter set may include all signal parameters of the received wireless signal 124, or only those parameters that have a significant effect on differentiating the mobile device 106 from other mobile devices in the room.

In many scenarios, multiple wireless signals 124 are needed to identify whether the mobile device 106 is in a given room. In such instances, a signal parameter set may be represented as a matrix

$$\hat{X} = \left(\begin{matrix}{\vec{X}}_{1} \\ {\vec{X}}_{2} \\ {\vec{X}}_{3} \\ ⋮ \\ {\vec{X}}_{7}\end{matrix}\right) = \left(\begin{matrix}{P}_{1 , 1} & {P}_{1 , 2} & {P}_{1 , 3} & ⋯ & {P}_{1 , N} \\ {P}_{2 , 1} & {P}_{2 , 2} & {P}_{2 , 3} & ⋯ & {P}_{2 , N} \\ {P}_{3 , 1} & {P}_{3 , 2} & {P}_{3 , 3} & ⋯ & {P}_{3 , N} \\ ⋮ & ⋮ & ⋮ & ⋱ & \\ {P}_{Z , 1} & {P}_{Z , 2} & {P}_{Z , 3} & & {P}_{Z , N}\end{matrix}\right) ,$$

where each X̅ⱼ is a vector-representation of the signal parameter set for room i, and Z is the number of rooms.

The occupancy probability may be expressed mathematically as y = P(0 = 1|X), i.e., the conditional probability that the mobile device 106 is in the room (0 = 1) given the parameter set X. In some embodiments, logistic regression is used to estimate the occupancy probability according to y = sig(w̅^{T}· X̅ + b), where sig() is the sigmoid function, w̅^{T} is a row vector of weights, b is an offset, and X is one signal parameter set expressed as a column vector. The sigmoid function serves as an artificial neuron of a neural network. Alternatively, the occupancy probability may be computed with another type of artificial neuron, such as a ramp function (e.g., rectified linear unit), softplus function, or step function.

The classifier 250 may be trained using machine-learning techniques known in the art. For example, optimal values for the weight W and offset b of the sigmoid function may be obtained to minimizing a cost function C that quantifies how “far” one solution (i.e., one choice of W and b) is from the optimal solution. One example of a cost function frequently used for training classifiers is the cross entropy:

$$C \left(O , y\right) = - O log y - \left(1 - O\right) log \left(1 - y\right)$$

A mean error E may be obtained by summing C over the complete set of m training values for a particular mobile device and room:

$$E \left(\vec{w} , b\right) = \frac{1}{m} {\sum }_{k = 1}^{m} C \left({O}_{k} , {y}_{k}\right)$$

The mean error E may then be minimized using known techniques, such as gradient descent.

In embodiments, training examples for training the classifier 250 include values of the supervisory signal 0 that are neither “1” (in-room) nor “0” (out-of-room). For example, consider the case where the mobile device 106 leaves the room, but the occupancy indication 334 is not updated to FALSE. In some embodiments, the signal analyzer 226 may monitor a GPS signal 353 or other positioning signal (e.g., from available networks not associated with the building in which the room is located) to infer that the mobile device 106 is no longer in the room. In this case, the first prompt 338 may be displayed to query a user (i.e., “It appears that you have left the room? Should I disconnect you from the display?”). If the user indicates to disconnect (i.e., generates the disconnect notification 342) and the GPS signal 338 indicates the mobile device 106 is, for example, 100 meters away from the room, then the classifier 250 may be trained with a training example in which the supervisory signal 0 is a likelihood that the mobile device 106 is still in the room (e.g., 0 = 0.8). Using a signal parameter set X determined from at least one wireless signal 124, the classifier 250 may then be trained with the training example (X, 0.8).

In certain embodiments, the classifier 250 is trained only with training examples for which the mobile device 106 is known to be in the room (e.g., the supervisory signal 0=1), such as when the occupancy indication 334 is set to TRUE when the user 222 enters the unique ID code 328 into the mobile device 106 via the interface 214. In such embodiments, the classifier 250 is trained to optimally predict when the mobile device 106 is in the room. However, the classifier 250 may not necessarily optimally predict when the mobile device 106 is out of the room.

In some embodiments, the occupancy determiner 200 uses generic device occupancy characteristics 360 to generate training examples for a new mobile device that has not yet transmitted to the occupancy determiner 200 any of its own training examples. For example, the new mobile device may belong to a new user that just entered the room but has not entered the unique ID code 328 into his or her mobile device. The generic device occupancy characteristics 360 may be stored on a server 370 connected to the network 204, or local to the occupancy determiner 200 in the memory 212. The generic device occupancy characteristics 360 may include previously trained classifiers 250, including previously-trained classifiers 250 trained with signal parameter sets from mobile devices of a particular brand and/or model.

As an example of how the occupancy determiner 200 may use the generic device occupancy characteristics 360, assume that the mobile device 106 is a certain brand of smartphone. Training examples received from the mobile device 106 (and optionally other mobile devices of the same brand and/or model) can be used to train the classifier 250 to predict occupancy of a new mobile device of the same brand, even if the new mobile device has not previously communicated any wireless-signal characteristics to the occupancy determiner 200. The more training examples received from a type (e.g., brand, model, age, etc.) of mobile device, the more accurate the classifier 250 can initially predict occupancy for a new mobile device of that type.

The classifier 250 may be trained to have knowledge of additional signal parameter sets indicating whether the corresponding mobile device 106 is either in-room or out-of-room. For example, the classifier 250 may be trained with a supervisory learning algorithm that monitors the at least one additional signal parameter set 352 to further train the classifier 250.

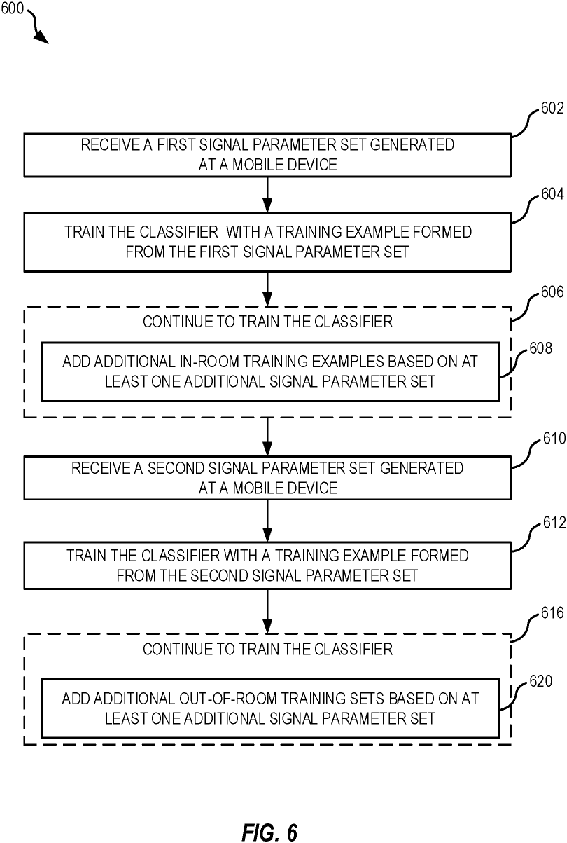

In embodiments, the supervisory learning algorithm (such as that shown in FIG. 6, discussed below) may monitor the additional parameter set 352 and, using knowledge of the occupancy data 240 of the mobile device 106, add additional training data to the classifier 250. For example, if the occupancy determiner 200 knows that the mobile device 106 is in the room, such as by receiving the first signal parameter set 336, any additional signal parameter set 352 received before receipt of the second signal parameter set 348 may be used by the supervisory learning algorithm to train the classifier 250 with the positive occupancy indication.

Any of the above-described features of the occupancy determiner 200 may be performed either remotely from the mobile device 106 or at the mobile device 106. For example, the occupancy determiner 200 may be located within or proximate to a smart display or a “pod”, such as the Solstice pod by Mersive Technologies Inc., or another device that is configured to perform the functionality of the occupancy determiner 200. In some embodiments, however, one or more features of the occupancy determiner 200 are integral with the mobile device 106 such that the mobile device 106 includes the classifier 250 and is able to process first, second, and additional signal parameter sets 336, 348, 352 to automatically determine its own occupancy data 240. The mobile device 106 may then transmit, via the mobile transceiver 216 and the network 204, the mobile-device-generated occupancy data 240 to a third-party device, such as a smart display, a “pod” (as described above) or an occupancy server. This configuration provides the advantage that additional hardware is not needed to implement the system 300. In other words, only the mobile device 106 (which may be a smartphone) is needed.

In some embodiments, the transmitter 208 is part of a wireless router physically located in the room and part of the network 204. In this case, the occupancy determiner 200 communicates to the wireless router (e.g., via wired means) to broadcast one wireless signal 124 and communicate with mobile devices. Furthermore, in this situation the occupancy determiner 200 no longer needs to be physically located in the room, and instead may be located elsewhere (e.g., as part of a network server located elsewhere), provided that the occupancy determiner 200 can communicate with the display device 330 (e.g., the display device 330 has a transceiver for connecting to the network 204).

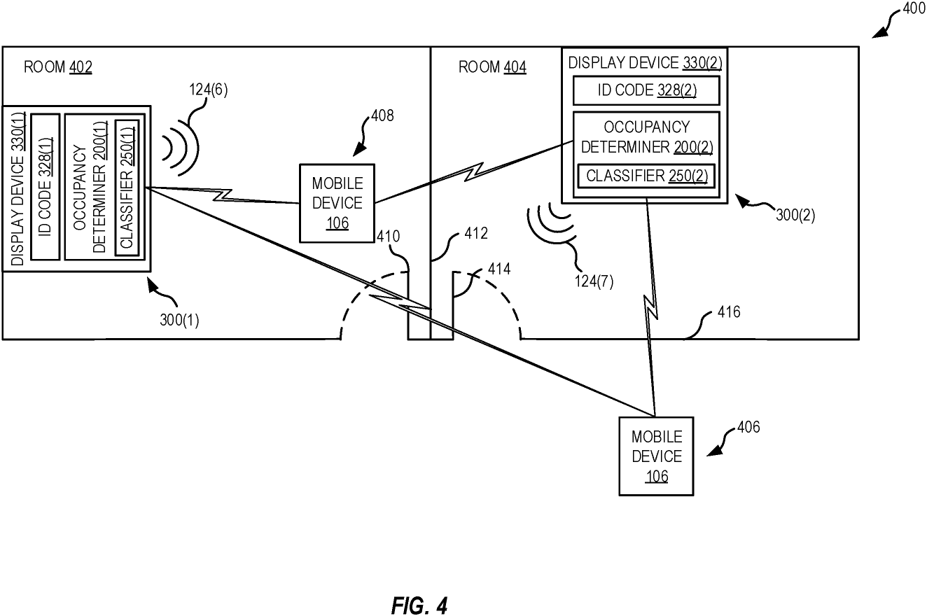

FIG. 4 depicts a room layout 400 showing first and second systems 300(1), 300(2) of FIG. 3 located in first and second rooms 402, 404, respectively. In the layout 400, the first system 300(1) includes a first occupancy determiner 200(1) located within a first display device 330(1), and the second system 100(2) includes a second occupancy determiner 200(2) located within a second display device 330(2). At a position 406, the mobile device 106 is in a hallway of the building (e.g., outside of the rooms 402 and 404). At a position 408, the mobile device 106 is in the room 402.

As shown in FIG. 4, obstacles may alter first and second wireless signals 124(6), 124(7) broadcast by the first and second occupancy determiners 300(1), 300(2), respectively. For example, at the position 406, the mobile device 106 may still receive the first wireless signal 124(6), but it is altered by a first door 410, a wall 412, and a second door 414. At the position 406, the mobile device 106 may also receive the second wireless signal 124(7), but it is altered by only a wall 416. At the position 408, the mobile device 106 may receive an unaltered version of the first wireless occupancy signal 124(6), and a version of the second wireless signal 124(7) altered by the wall 412. In some scenarios, signal parameter sets generated from both wireless signals 124(6), 124(7) may improve the accuracy of both the first and second occupancy determiners 300(1) and 300(2) by providing additional training examples for training the classifiers 250(1) and 250(2). For example, if the mobile device 106 generated a signal parameter set from only the second wireless signal 124(7), the signal parameters may be the same at both positions 406 and 408. Use of additional wireless signal 124 therefore improves the quality of the training examples and the accuracy of the classifiers 250.

Multiple classifiers (e.g., classifier 250) may be generated for each room, and in certain embodiments, each mobile device. For example, FIG. 4 shows the first classifier 250(1) associated with the first room 402, and the second classifier 250(2) associated with the second room 404. As such, when a new room (the kth room) is fitted an occupancy determiner 200 and/or system 300, and connected to the mobile device 106, a new classifier Nₖ is instantiated and a signal sample X at that moment of connection is used to begin training the classifier Nₖ. Eventually, the mobile device 106 is able to query several classifiers to determine if one mobile device recognizes a room (the network Nₚ network, for example, returns a probability close to 1, indicating that the one mobile device is in the pth room).

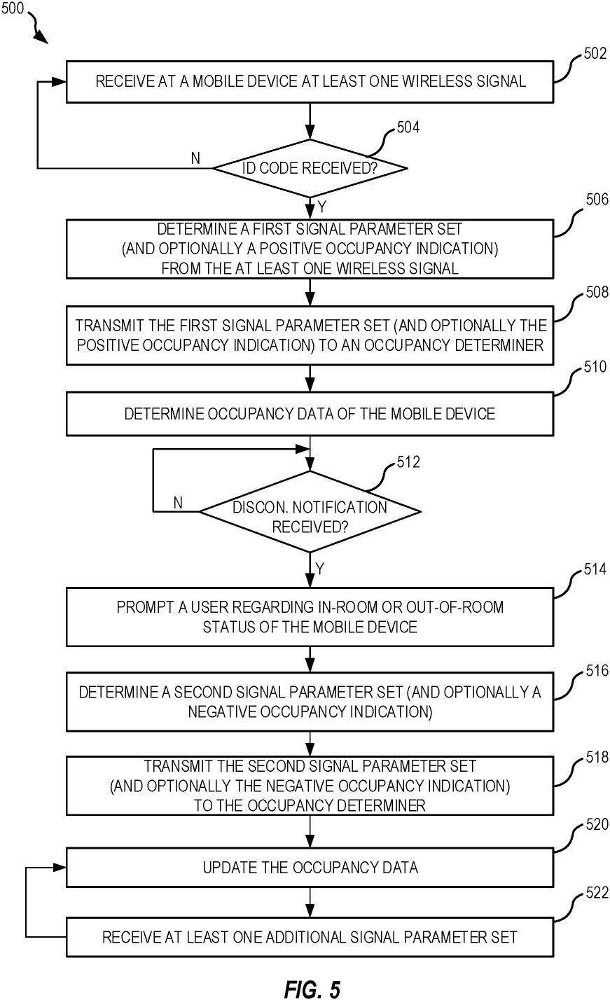

FIG. 5 shows one example of a method 500 that determines occupancy of a mobile device in a room. The method 500 may be implemented using one or more components of the occupancy determiners 100 and 200 described above and shown in FIGS. 1-4. At a block 502, the method 500 receives, at a mobile device, at least one wireless signal. In one example of the block 502, the mobile device 106 receives at least one wireless signal 124.

At a block 504, the method 500 determines if a unique ID code is received at the mobile device. If the unique ID code is received at the block 504, the method 500 proceeds to a block 506, else the method 500 continues to the block 502 to receive at least one wireless signal. In some embodiments, the method 500 does not affirmatively “receive” a wireless signal (i.e., process and store the data associated with the wireless signal) at block 502 until the unique ID code is received at the block 504. In one example of the block 504, the unique ID code 328 associated with the occupancy indicator 200 is inputted to the mobile device 106 via the interface 214, and stored in the mobile device 106 as the inputted ID code 332.

At a block 506, the method 500 determines a first signal parameter set (and optionally a positive occupancy indication) from the received wireless signal at the time the input ID code was inputted at the block 504. In one example of the block 506, the signal analyzer 226 generates the first signal parameter set 336 (and optionally sets the occupancy indication 334 to TRUE).

At a block 508, the method 500 transmits the determined first signal parameter set (and optionally the positive occupancy indication) to an occupancy determiner. In one example of the block 508, where the occupancy determiner 200 is remote from the mobile device 106, the first signal parameter set 336 (and optionally the positive occupancy indication 334) is transmitted via the mobile transceiver 216 and the network 204 to the occupancy determiner 200. In embodiments where the functionality of the occupancy determiner 200 is implemented within the mobile device 106, the block 508 may simply include accessing, using the occupancy determiner 200, the stored first signal parameter set 336 (and optionally the positive occupancy indication 334) from the mobile memory 220.

At a block 510, the method 500 determines occupancy data of the mobile device. In one example of the block 510, the occupancy determiner 200 determines the occupancy data 240 of the mobile device 106. In embodiments where the functionality of the occupancy determiner 200 is implemented within the mobile device 106, the occupancy data 240 may be transmitted from the mobile device 106 to an external device at the block 510.

At a block 512, the method 500 determines if a disconnect notification is received. If yes, the method 500 proceeds to a block 514, else the method 500 loops until a negative occupancy indication is received at the block 512. In embodiments, if a disconnect notification is not received at the block 512 for a predetermined period of time, the method 500 may perform one iteration of the block 514. In one example of the block 512, the mobile device 106 determines if the disconnect notification 342 is received.

At the block 514, the method 500 prompts a user regarding in-room or out-of-room status of the mobile device. In one example of the block 514, the second prompt 344 is displayed automatically via the interface 214 to the user 222 requesting whether the mobile device 106 is in-room or out-of-room.

In a block 516, the method 500 determines a second signal parameter set device (and optionally a negative occupancy indication) from another at least one received wireless signal measured by the mobile. The block 516 may be initiated when the response to the prompt of the block 514 indicates the mobile device is out-of-room. In embodiments, the block 516 may be initiated automatically when the disconnect notification is received at the block 512. In one example of the block 516, the signal analyzer 226 determines the second signal parameter set 348.

At a block 518, the method 500 transmits the determined second signal parameter set (and optionally the negative occupancy indication) to the occupancy determiner. In one example of the block 518, where the occupancy determiner 200 is remote from the mobile device 106, the second signal parameter set 348 (and optionally the negative occupancy indication 334) is transmitted via the mobile transceiver 216 and network 204 to the occupancy determiner 200. In embodiments where the functionality of the occupancy determiner 200 is implemented within the mobile device 106, the block 518 may simply include accessing, using the occupancy determiner 200, the stored second signal parameter set 348 (and optionally the negative occupancy indication 334) from the mobile memory 220.

At a block 520, the method 500 updates the occupancy data related to the mobile device. In one example of the block 520, the occupancy determiner 200 updates the occupancy data 240 with respect to the mobile device 106. In embodiments where the functionality of the occupancy determiner 200 is implemented within the mobile device 106, the occupancy data 240 may be transmitted to a third-party device remote from the mobile device 106.

At a block 522, the method 500 receives at least one additional signal parameter set. In one example of the block 522, the occupancy determiner 200 receives at least one additional parameter set 352 from the mobile device 106. The method 500 then repeats block 520 based on additional parameter sets.

FIG. 6 shows one example of a method 600 that trains a classifier used to determine room occupancy. The method 600 may be implemented by the occupancy determiner 200, whether within the mobile device 106 or remotely located therefrom, to train the classifier 250. The method 600, or parts thereof, may represent a supervisory learning algorithm that trains the classifier 250.

At a block 602, the method 600 receives a first signal parameter set generated at a mobile device. In one example of the block 602, the occupancy indicator 200 receives the first signal parameter set 336 from the mobile device 106. At a block 604, the method 600 trains a classifier with a training example formed from the first signal parameter set and a supervisory signal. In one example of the block 606, the occupancy determiner 200 creates a training example by combining the first signal parameter set 336 and the positive occupancy indication 334. The occupancy determiner 200 then trains the classifier 250 with the training example0

In some embodiments, the method 600 includes a block 606 wherein the method 600 continues to train the classifier with training examples formed from additional signal parameter sets. In some of these embodiments, the block 606 has a sub-block 608 wherein the method 600 adds additional in-room training examples from additional signal parameter sets generated when the mobile device was known to be in the room. In one example of the sub-block 608, at least one additional signal parameter set 352 is known to be generated at the mobile device 106 when the mobile device 106 is in the room because it was generated after the occupancy indication 334 was set to TRUE and before the occupancy indication 334 was set to FALSE. In some embodiments of the sub-block 608, at least one additional signal parameter set 352 is known to be generated at the mobile device 106 when the mobile device 106 was in the room because it was generated after the first signal parameter set 336 (or an additional signal parameter set 352 matching the first signal parameter set 336), and before the second signal parameter set 348 (or an additional signal parameter set 352 matching the second signal parameter set 348).

At a block 610, the method 600 receives a second signal parameter set generated at the mobile device. In one example of the block 610, the occupancy indicator 200 receives the second signal parameter set 348 from the mobile device 106. At a block 612, the method 600 trains the classifier with a training example formed from the second signal parameter set and a supervisory signal. In one example of the block 612, the occupancy determiner 200 creates a training example by combining the second signal parameter set 348 and the negative occupancy indication 334. The occupancy determiner 200 then trains the classifier 250 with the training example.

In some embodiments, the method 600 includes a block 616 wherein the method 600 continues to train the classifier with training examples formed from additional signal parameter sets. In some of these embodiments, the block 616 has a sub-block 620 wherein the method 600 adds additional out-of-room training examples from additional signal parameter sets generated when the mobile device was known to be out of the room. In one example of the sub-block 620, at least one additional signal parameter set 352 is known to be generated at the mobile device 106 when the mobile device 106 was out the room because it was generated after the occupancy indication 334 was set to FALSE. In some embodiments of the sub-block 620, at least one additional signal parameter set 352 is known to be generated at the mobile device 106 when the mobile device 106 was out of the room because it was generated after the second signal parameter set 348 (or an additional signal parameter set 352 matching the second signal parameter set 348).

In some embodiments, that method 600 may be used in conjunction with the method 500, such that the additional signal parameter sets received at block 522 of the method 500 are also used to generate additional training examples for training the classifier.

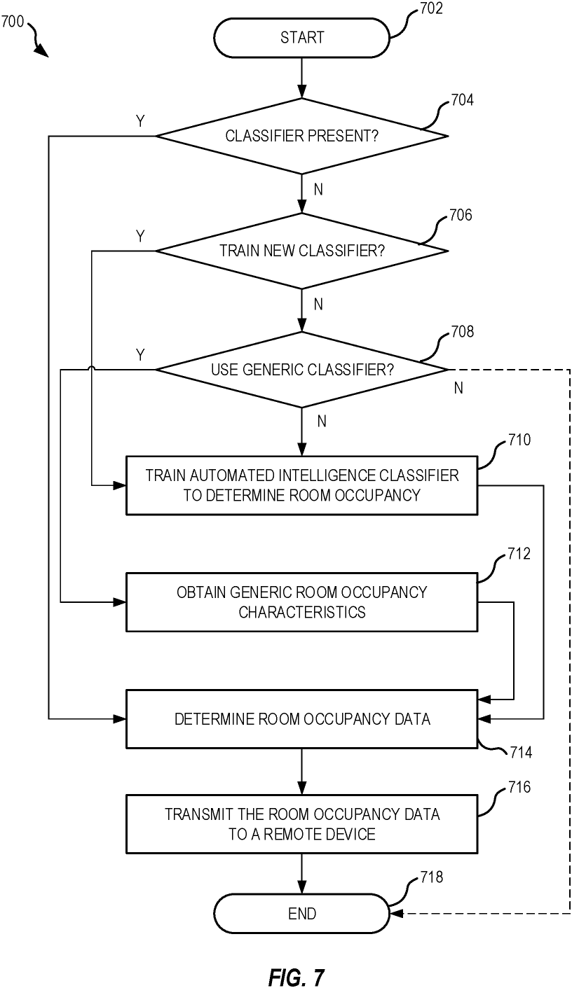

FIG. 7 shows one example of a method 700 that determines occupancy of a mobile device in a room. The method 700 may be implemented using one or more components of the occupancy determiners 100 and 200, as described above and shown in FIGS. 1-4. The method 700 begins at a block 702. In one example of operation, the method 700 is triggered upon receipt, at the mobile device 106, of the input ID code 332 into a room-occupancy application running on the mobile device 106.

At a decision block 704, a mobile device determines if a classifier already exists to determine room occupancy of the mobile device. If yes, the method 700 proceeds with a block 714, else the method 700 proceeds with a block 706. In one example of the block 704, the mobile device 106 communicates with the occupancy determiner 200 to determine whether the occupancy determiner 200 previously instantiated (i.e., generated and trained) an already-existing classifier 250 that can be used with wireless-signal characteristics measured by the mobile device 106. The already-existing classifier may be one of several such classifiers stored in the occupancy determiner 200 and used by the occupancy determiner 200 to determine occupancy of multiple mobile devices in the single room. The already-existing classifier may correspond to a type of the mobile device 106 (e.g., make and/or model), wherein the occupancy determiner 200 stores and utilizes one classifier 250 for each type of mobile device. Alternatively, the already-existing classifier may be unique to the mobile device 106, wherein the occupancy determiner 200 stores and utilizes one classifier 250 for each mobile device (either currently and/or previously in the room). Alternatively, the already-existing classifier may be only one classifier 250 used for all mobile devices 106 in the room, regardless of type.

In one example of the block 704, the occupancy determiner 200 is remotely located from the mobile device 106, and the mobile device 106 transmits the mobile device ID 254 to the occupancy determiner 200 via the network 204. The occupancy determiner 200 then compares the mobile device ID 254 to registered classifiers 250 to determine if an already-existing classifier 250 may be used with the mobile device 106. Where the occupancy determiner 200 is integral with the mobile device 106, the mobile device 106 searches the mobile memory 220 to determine if an already-existing classifier 250 has been generated for the given room associated with the input ID code 332.

At the decision block 706, the method 700 determines if a new classifier is to be generated and trained with wireless-signal characteristics from the mobile device. If yes, the method 700 proceeds with a block 710, else the method 700 proceeds with a block 708. In one example of the block 700, a prompt is presented on the interface 214 requesting if the user 222 wants to train a new classifier for the mobile device 106 or the type of the mobile device 106. In another example of the block 706, settings within the occupancy determiner 200 or mobile device 106 are queried to determine if a new classifier is to be trained for the mobile device 106 or the type of the mobile device 106.

At a decision block 708, the method 700 determines if a generic classifier is to be used for the new classifier. If yes, the method 700 proceeds with a block 712, else the method 700 either (1) proceeds with the block 710 to train the generic classifier with the mobile device and register the trained generic classifier with the occupancy determiner 200, or (2) ends at a block 718 without determining occupancy of the mobile device. In one example of the block 708, a prompt is presented on the interface 214 requesting if the user 222 wants to instantiate the new classifier using the generic device occupancy characteristics 360 (e.g., via the server 370 or the occupancy determiner 200) for the type of the mobile device 106. In another example of the block 708, settings within the occupancy determiner 200 or mobile device 106 are queried to determine if the new classifier is to be instantiated with the generic device occupancy characteristics 360.

In a block 710, the method 700 trains an automated intelligence classifier that determines occupancy of the mobile device. The block 710 is implemented using any of the above described systems and methods for generating and/or instantiating any existing classifier 250. For example, the block 710 may be implemented using any one or more steps of the methods 500 and 600 discussed above. Furthermore, in one embodiment the automated intelligence classifier is only trained to predict when the mobile device 106 is in the room, and not when the mobile device 106 is out of the room. In another embodiment, the automated intelligence classifier is trained to predict both when the mobile device 106 is in the room and out of the room.

In the block 712, the method 700 obtains generic device occupancy characteristics for the type of the mobile device. In one example of the block 712, the mobile the occupancy determiner 200 downloads the generic device occupancy characteristics 360 (e.g., from the server 370 via the network 204) that match one or more of the brand, model, and operating system of the mobile device 106. In another example of the block 710, the mobile device 106 downloads the generic device occupancy characteristics 360, from the occupancy determiner 200 via network 204, that match one or more of the brand, model, and operating system of the mobile device 106.

In the block 714, the method 700 determines room occupancy data of the room, including the mobile device, using one of (1) the already-existing classifier identified in the block 704, (2) the new generic classifier generated in the block 706, and (3) the automated intelligence classifier trained in the block 710. In one example of the block 714, a signal parameter set (e.g., the first signal parameter set 336, second signal parameter set 348, and/or additional signal parameter set 352) is generated by the signal analyzer 226 of the mobile device 106, and transmitted to the occupancy determiner 200. The occupancy determiner 200 inputs this signal parameter set to the corresponding classifier 250 to generate the occupancy data 240 for the mobile device 106. Where the occupancy determiner 200 is located remotely from the mobile device 106, the signal parameter set is transmitted from the mobile device 106 to the occupancy determiner 200 via the network 204 prior to generating the occupancy data 240.

In a block 716, the room occupancy data is transmitted to a remote device. In one example of the block 716, the occupancy determiner 200 transmits the room occupancy data 240 to one or more of the server 370, a third-party server (such as a building occupancy management server), the display device 330, and another device. If the occupancy determiner 200 is integral with the mobile device 106, then the occupancy data 240 is transmitted from the mobile device 106 to one or more of the server 370, a third-party server (such as a building occupancy management server), the display device 330, and another device via the network 104. In another example of the block 716, when the mobile device 106 transmits occupancy data 240 to, for example, the display device 330, the mobile device 106 automatically connects to the display device 330 (or another device, such as the Solstice Pod manufactured by Mersive Technologies, Inc.) to allow the mobile device 106 to interact with the device 330.

At the block 718, the method 700 ends. The method 700 may repeat, either periodically or aperiodically (e.g., when the data associated with the method 700 changes), to update the occupancy data of the room in real-time. Furthermore, the method 700 may be performed on a plurality of devices such that for any given room the occupancy of that room is known automatically.

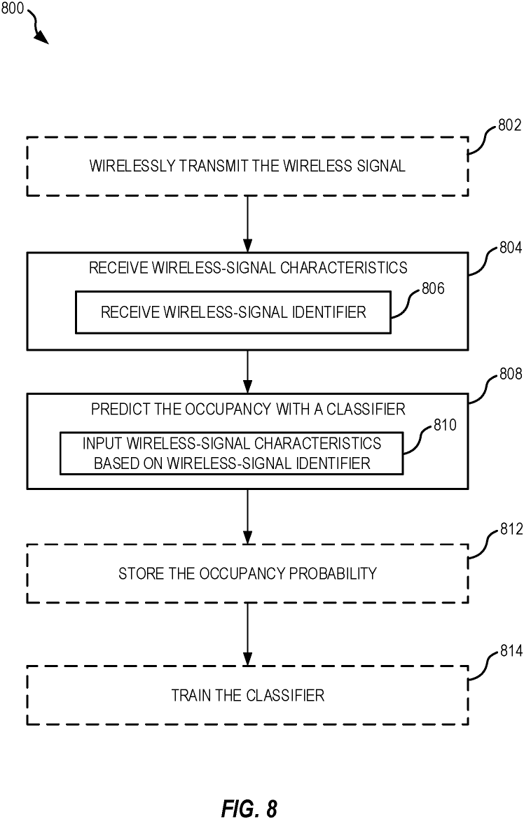

FIG. 8 shows one example of a method 800 that determines occupancy of a mobile device in a room. The method 800 may be implemented using one or more components of the occupancy determiners 100 and 200, as described above and shown in FIGS. 1-4.

In a block 804, the method 800 receives wireless-signal characteristics measured by the mobile device from a wireless signal. In one example of block 804, the mobile device 106 transmits the first signal parameter set 336 to the occupancy determiner 200 via the network 204. In one embodiment, the block 804 includes a sub-block 806, wherein the method 800 receives a wireless-signal identifier of the wireless signal detected by the mobile device, the wireless-signal identifier uniquely identifying the wireless signal. In one example of the sub-block 806, the mobile device 106 transmits the mobile device ID 254 to the occupancy determiner 200 via the network 204.

In a block 808, the method 800 predicts the occupancy of the mobile device in the room by using a classifier to calculate an occupancy probability from the received wireless-signal characteristics. In one example of block 808, the occupancy determiner 200 calculates the occupancy probability 256 from the wireless-signal characteristics 236 measured by the mobile device 106. In one embodiment, the block 808 includes a sub-block 810, wherein the method 800 inputs the wireless-signal characteristics to the classifier based on the wireless-signal identifier. In one example of the sub-block 810, the feature-vector generator 262 forms the feature vector 258 from the wireless-signal characteristics 236, wherein the occupancy determiner 200 inputs the feature vector 258 to the classifier 250.

In some embodiments, the method 800 includes a block 812, wherein the method 800 stores the occupancy probability. In one of these embodiments, the method 800 receives a mobile device ID from the mobile device, and stores the mobile device ID with the occupancy probability of the mobile device. In one example of the block 812, the occupancy determiner 200 receives the mobile device ID 254 from the mobile device 106, and stores the occupancy probability 256 with the mobile device ID 254 in the occupancy data 240.

In other embodiments, the method 800 includes a block 814, where the method 800 trains the classifier with a training example formed from an occupancy indication and the received wireless-signal characteristics. The occupancy indication may be a positive occupancy indication verifying that the mobile device was in the room when the mobile device measured the at least one wireless signal, or a negative occupancy indication verifying that the mobile device was out of the room when the mobile device measured the at least one wireless signal. In one example of the block 814, the occupancy determiner 200 forms a training example by combining the received occupancy indication 334 with one of the first signal parameter set 336, the second signal parameter set 348, and the additional signal parameter set 352. The occupancy determiner 200 then trains the classifier 250 with the training example.

In other embodiments, the method 800 includes a block 802, wherein the method 800 wirelessly transmitting the wireless signal measured by the mobile device. In one example of the block 802, the occupancy determiner 200 transmits a wireless signal 124(5) that is measured by the mobile device 106 to obtain wireless-signal characteristics.

### Pre-clustering and Geolocation Selection

To determine occupancy of one or more mobile devices in a plurality of rooms, a plurality of binary classifiers may be used, with at least one binary classifier for each specific room. Alternatively, a single multinomial classifier may be used to determine occupancy for all the rooms. The difference between these two these implementations of the classifiers has significant merits in terms of scalability and retraining of ANNs having a high degree of variability. In situations where an emitter is moved, removed, or new devices/locations are added, a single multinomial classifier would constantly require updating, rescaling, and/or retraining. Moreover, the overall size and computational complexity of a set of multiple binary classifiers is proportional to the sum of the number of elements in each of the binary classifiers (e.g., the number of input nodes of each ANN), whereas a multinomial classifier scales with the product of the number of elements in each classifier. Finally, multiple binary classifiers offer processing optimizations over a single multinomial classifier whereby several binary classifiers can be trained or classified simultaneously using computer systems with multiple processors and/or threads.

Regardless of classifier implementation, computing performance and scalability may become problematic when many (e.g., thousands) devices/locations need to be learned. This is often the case for big organizations with distributed resources over multiple campuses in various geographical regions. In these cases, the sheer number of binary classifiers can become cumbersome and unwieldly to manage, train, and utilize. Fortunately, a large set of binary classifiers may be grouped into classifier-clusters that are themselves more amenable to the overarching performance requirements. When a particular binary classifier is needed (e.g., for classification or training), the appropriate cluster is first identified, and then only the binary classifiers contained therein need be considered.

In one embodiment, binary classifiers are grouped into classifier-clusters using measured locations of the corresponding rooms. The location of the rooms may be obtained, for example, via GPS or proximity to a network access point whose source position is known. Several binary classifiers may then be grouped into one classifier-cluster when they are similarly located (e.g., within the same building). In another embodiment, a trained multinomial classifier (e.g., a decision tree, k-means, k-nearest, neural network, etc.) receives a feature vector and outputs the cluster contains the corresponding binary classifier. Such a system could be further automated by utilizing auto-clustering, wherein the clusters themselves are programmatically rebalanced (i.e., the binary classifiers are moved between clusters) as various locations are added, moved, removed.

### Hashing

Classifiers receive an input feature vector (e.g., see feature vector 258 in FIG. 2) whose individual elements represent different quantities that are to be learned by the classifier. These elements may be thought of as orthogonal axes in a high-dimensional space where, for example, the first element represents a signal strength of a first emitter, the second element represents a signal strength of a second emitter, and so on. While this simple mapping between wireless-signal characteristics and feature-vector elements works well for many applications (e.g., image processing, regression, etc.) the nature of the environment and signal measured for device/location classification make this approach unacceptable. From one signal-scan (e.g., as implemented by the wireless-signal detector 248 of FIG. 2) to the next there may be fewer or more emitters and their relative order may be very different.

While the simple mapping may mitigate this problem to some extent, it requires a priori knowledge of the entire set of possible emitters that may be measured in a given room. The sudden introduction of a new emitter necessitates a completely restructuring and retraining of any/all classifiers that may process the given feature vector. Being that the many of the wireless signals (e.g., Wi-Fi, Bluetooth, BLE, etc.) are often emitted by mobile devices that come and go from a room, the chances of transient signals being detected is very high. Furthermore, antenna directionality causes wireless signals to be readily seen and dropped as the user’s location/orientation changes even slightly.

In one embodiment, a feature vector is constructed by reserving a large number (approximately two orders-of-magnitude more than the number of expected emitters) of elements. For a given emitter, the hash (md5, Shaa1, etc.) of its wireless-signal UID may be computed and modulated by the length (i.e., remainder) of the feature vector. This yields a repeatable and generally unique index of the feature vector where the emitter’s corresponding wireless-signal characteristics may be entered sequentially. Further, with such a large feature vector, the chances of hash collisions among different emitters is diminished (specifically, the “Birthday Problem” can be considered and the precise probability of collision computed). Finally, as transient emitters come and go, their presence in the feature vector likely does not collide with fixed/stable emitters but rather the corresponding indices are just learned as noise/unimportant by the classifier.

In other embodiments, hashing is implemented based on the types of wireless signals (e.g., Wi-Fi, BLE, cellular, etc.). This is equivalent to forming several sub-feature vectors, one for each signal type, and concatenating the sub-feature vectors together to form a single final feature vector. Furthermore, some very stable and/or reliable wireless signals (e.g., Wi-Fi Access Point, beacons, etc.) may be “registered” with the classifiers, corresponding elements of the feature vector reserved therefore. In this way, prominent emitters will be guaranteed to never collide with transient sources. In one embodiment, the “reserved” emitters are dynamically learned and set without administrator configuration/interaction.

### Location-Aware Learning

In one embodiment, each classifier is retrained with an entire set of previously-collected training examples combined with a new training example. Various permutations of back propagation may be performed with these training examples. Additionally, a metric (e.g., sample collection time, mean difference between elements of a feature vector and an average feature vector, etc.) may be use to select a subset of previously-collected past training samples.

In another embodiment, classifiers are one-step trained, i.e., trained using only the new training example. As new training examples become available, one or more steps of back propagation are performed. This approach has several benefits, including: (1) training examples need not be stored, sorted, or otherwise managed for use in future training, (2) evolving signatures (e.g., fixed emitters being added/moved/removed) can be automatically handled as the classifier adapts to a changing cost-function minimum, and (3) it is generally faster and far more efficient to run a few rounds of backpropagation than to retrain a classifier with an entire set of training examples.

When retraining or backpropagating with a training set of past and/or current training examples, it may be desirable to scale and/or normalize the numbers of positive and negative samples within the training set. Particularly in cases where the number of classifiers is large, a training set may become excessively uneven, i.e., there may be more significantly more negative samples than positive samples. This imbalance is a consequence of the fact that if N locations are trained with one training example collected in each location, then for any given location there will be only one positive training example but (N-1) negative training examples. In one embodiment, normalization of the training set may be accomplished by modifying the step-length used during back propagation, and scaling by a multiple of 1 for a positive case or by ⅟(N-1) for negative cases. In another embodiment, the training set may be normalized by simply duplicating test cases; negative cases are not duplicated, but positive samples are duplicated by a factor of (N-1).

FIGS. 1 - 8 and their description herein illustrate an exemplary embodiment of using observations of wireless signals by mobile devices to identify a geospatial location of the mobile device in a physical office space as well as the proximity of one device to another. In an embodiment, a more general method and apparatus for using a greater variety of device observations to autonomously cluster a variety of devices through correlation and spatial grouping will now be described.

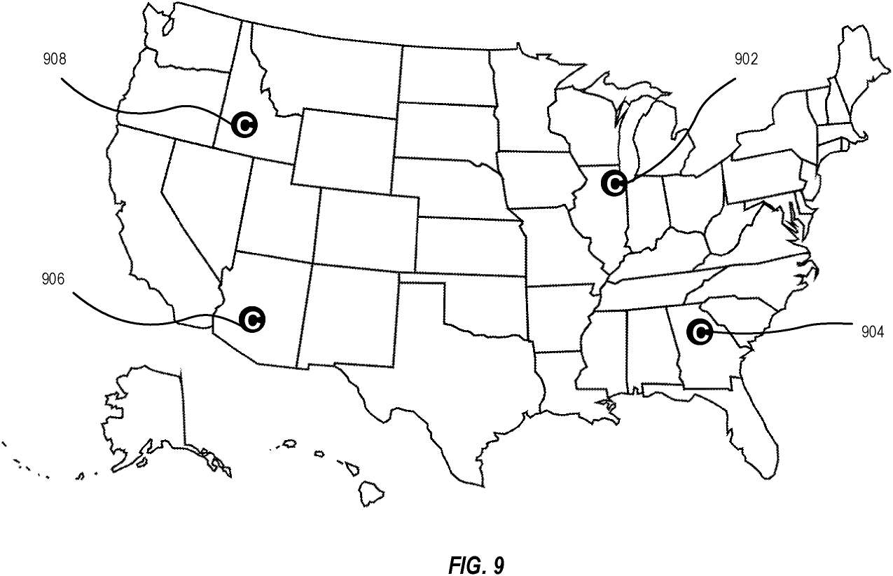

FIG. 9 illustrates a set of clusters with spatially defined locations as represented at 902, 904, 906 and 908. Each cluster represents a physical office space for a business or organization that maintains a fixed and mobile digital infrastructure.

As depicted in FIG. 9, clusters 902, 904, 906 and 908 represent physical office spaces in the cities of Chicago, Atlanta, Phoenix and Boise, respectively. These locations are identified for purposes of illustration principles herein however, a physical office space, or spatially defined location, may be located anywhere in the United States or other countries. A physical office space may include one or more floors of a multi-story office building, or single story building, for example. Other configurations are contemplated.

A business may maintain fixed digital infrastructure in physical office spaces such as desk-top computers, routers, printers, video conferencing systems and servers. The business may also provide non-fixed devices such as laptops, as well as mobile devices like smartphones. A mobile device may be one provided for an employee’s use, or a personal device with applications installed for business use.

The notion of a clustering devices according to spatially defined locations allows for data and characteristics to be shared across devices contained within a cluster. Classifying a device as part of a cluster of devices and therefore, present in a physical office space provides advantages to a user of the device. For example, print menus often provide a selection of printers. Assuming that a user wants to print something for their use, it is more convenient to the user to have the print menu show only those printers that are in the same office space and/or close to the user. The same is true for other resources such as video conference rooms or even other mobile user devices.

A method of clustering co-located devices by correlating measurable quantities, or observations, made by the devices is described herein. Given a set of interactive devices (i.e., video conferencing system host devices) distributed across a business’s offices worldwide, it is desired to determine in an autonomous fashion:
a. which devices are co-located in a given office,
b. when any given device should move from one office to another, and/or
c. which office a new device (or user) is likely in when it first comes online.

Not all devices maintained by a business have spatial estimation capability (i.e., GPS). Allowing that both fixed and mobile user devices can make measurements of other observables (i.e., electro-magnetic radiation, acoustic wave signatures, atmospheric conditions, etc.) these measurements can further be used to cluster devices.

A “cluster state” is defined as a collection of observations that are correlated to each other. In a system that only analyzes/predicts proximity for each device singularly, accuracy is severely limited by the narrow set of observations of that one device. To contrast, if we had a priori knowledge that two devices were in adjacent rooms, then any location sample observed by one device (or user connection to said device) could equally apply to the other device (and especially so if the uncertainty is opened up to account for it having come from the other room). Likewise, an RF emitter observed near one device would likely be observed at the other, and so the system can form a larger “pool” of observables that should define a cluster state. In this sense, the cluster becomes not just a geo-spatial construct, but broadens to include all observables that are common across it that are maintained as a cluster state.

Previously, it was mentioned that “if we had a priori knowledge that two devices were in adjacent rooms” and that certainly suggested that “a priori knowledge” was required. In fact, however, this is not the case and the system disclosed herein can autonomously and accurately auto-cluster as data from observations becomes available. This is achieved by evaluating observations as they come for consistency with the previously assigned cluster and re-assigning as needed.

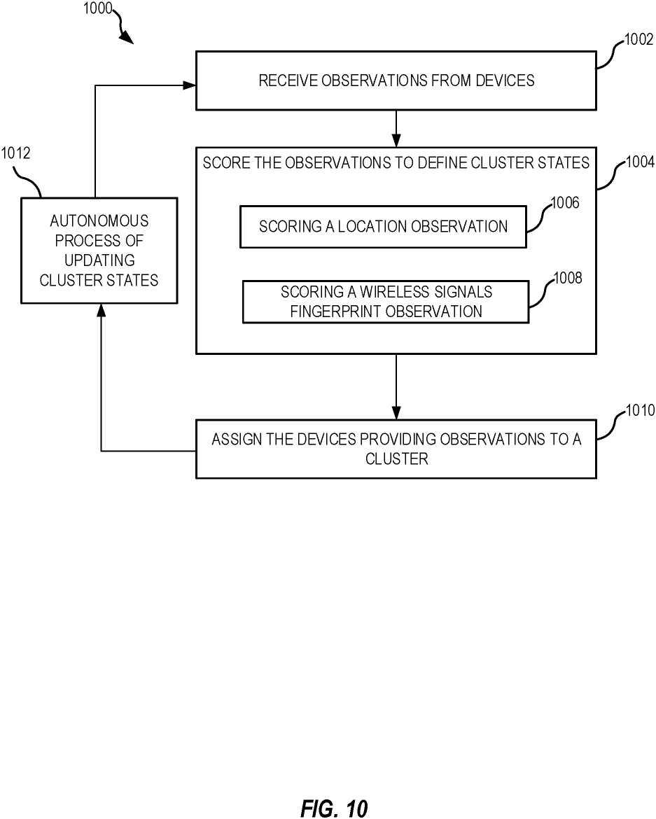

FIG. 10 illustrates a flowchart of a method of clustering devices according to spatially defined locations, in embodiments. In some embodiments, methods disclosed herein are performed on host computers forming part of video conferencing systems in the spatially defined location of a business. In other embodiments, methods may be performed on servers in one or more spatially defined locations, or in the cloud. In further embodiments, methods may be performed on a combination of host computers, servers, cloud devices, and other computing devices maintained by the business. A processing circuitry is maintained by the business for executing the clustering method disclosed herein.

In step 1002, devices provide observations to the processing circuitry. In an example of step 1002, devices may include mobile device 106 and occupancy determiner 200 or equivalents. Devices may also include laptops, printers, routers, host computers of video conferencing systems and any other type of computing device. Devices provide observations using an application maintained by the business on the device. Observations may be provided on start-up of a device or periodically, such as at 15 second intervals. Observations may also be triggered by events external to the device, such as initialization of another device. In embodiments, devices may also have a user-controlled function to provide an observation.

Observations are a measurable metric that is detected by a device. An observation may be communicated to the processing circuitry wirelessly, over a wireless or cellular network, for example. In embodiments, the number of measurable metrics in any given observation may be less than the number of measurable metrics in the cluster state. For example, a cluster state may include observations of EM radiation, emitter characteristics, audio signatures and atmospheric conditions, for example, as well as certain measured signal characteristics such as average power, frequency response (e.g., Fourier coefficients), or ratios of Fourier coefficients. Observations may even include using the camera of a device to sample room color or identifying Bluetooth® devices such as wireless keyboards or headsets. Any given device providing an observation may not be able to detect all of these properties and/or characteristics.

In step 1004, observations are scored to define cluster states. In an example of step 1004, observations are scored to define a cluster state at each of the spatially defined locations, wherein the cluster state comprises a plurality of measurable quantities.

For this reason, there is a layer of “data fusion” that must be performed when scoring observations against clusters. An “observation” is a super-set of all possible observable quantities that can be made by both fixed and mobile, or user-connected, devices such as laptops and smartphones. A single observation will contain some subset of all these measurables. The method disclosed herein is able to score each observation against a set of past observations, each with their own sub-set of the measurables. Part of scoring an observation includes evaluating the observation for consistency within a cluster state.

Scoring an observation may be accomplished in a variety of ways depending on the measurable metrics in the observations. Each individual measurable can be scored against itself according to whatever unique metric is called for.

In step 1006, an observation is location, such as a measurable metric provided by a GPS sensor or registration with a cellular network. In an example of step 1006, scoring a location observation may use the uncertainty ellipsoid of the sample and integrate through the bounds of a cluster bounding-box to determine a probably of inclusion.

In step 1008, an observation is a wireless signals fingerprint such as a set of MAC addresses and RSSI scores. In an example of step 1008, scoring a wireless signals fingerprint observation may use a Bloom Filter to count the number of emitters regularly seen within the cluster. Use of a Bloom Filter to score observations will be described in more detail below.

In general, observations can be scored against the cluster to yield a vector of scores for each measurable quantity. Only those measurables that were provided in the observation will be scored and so the vector may be sparse and filled with many NULLs. While this score-vector represents a large step in data reduction (from a huge set of measurables to just a few simple scores) there is still a need to correlate the vector to a single cluster-inclusion score. In embodiments, a set of heuristics can be used to reduce the score vector to a scalar. In further embodiments, a classifier can be trained and used to perform the final reduction (regression). In this way, reinforcement learning can be used to make the cluster scoring adaptive and overcome changes (like ever improving capabilities in user devices) that heuristics would normally miss.

In embodiments, a neural network classifier is trained to reduce the vector of scores to assign a device associated with an observation to the spatially defined location associated with a highest scoring cluster state. A classifier is a type of learning algorithm that finds solutions to an optimization problem. Typically, a training set of observations will be used to develop a model which can then classify, or score, observations to assign devices making the observations to a cluster. Clusters can evolve over time or due to the movement of devices into or out of the spatially defined location of the cluster.

In step 1012, observations are received and scored as an autonomous process of updating cluster states. In an example of step 1012, assigning the devices to a cluster in step 1010, method returns to step 1002 where additional observations of measurable metrics are received from the devices and scored against cluster states so that cluster states are updated autonomously based on the additional observations. An evolving and adaptive system is then created whereby observations continue to flow in and cluster states change and converge quickly.

In embodiments, new observations from devices are blindly classified against all clusters and the “best” cluster is then updated. As used herein, new observations include observations from a device that is newly associated with a business as well as observations from a device that has entered a spatially defined location or moved from one spatially defined location to another. In this way, movement events can be created if the best cluster and previously assigned cluster were not one in the same, or if they were, then the prior-assigned cluster’s state can be further reinforced. In embodiments, a host computer may also move to a new location, such as a hotel conference center or a client site, identify that it is no longer associated with its previous cluster, and form a new cluster as mobile devices are registered with the host computer.

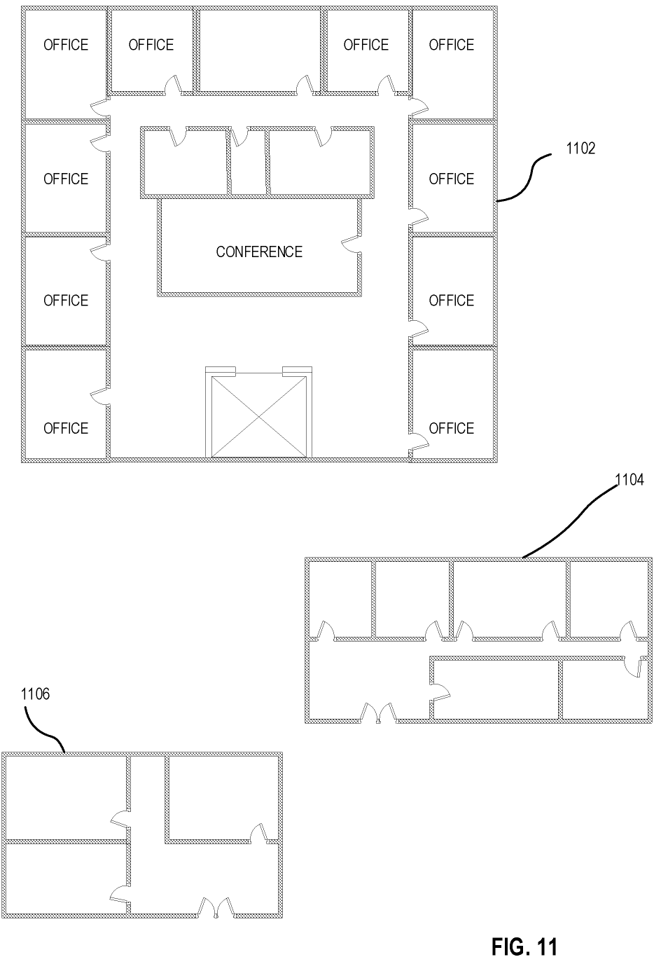

The same processing circuitry that performs the scoring for auto-clustering purposes, can be also used to score new observations or classification requests. FIG. 11 illustrates three office spaces 1102, 1104 and 1106, each with multiple rooms. Office spaces 1102, 1104 and 1106 are examples of the spatially defined locations of clusters 902, 904 and 906 of FIG. 9. When a new device is powered on within a building, or a user enters an office space, the business-maintained application running on the device can be caused to take a sample of all emitters it can see at that time, for example. Other observations, such as audio noises or visual characteristics may also be captured. The same scoring methodology can be utilized to quickly estimate which office this corresponds. In embodiments, new observations from devices are blindly classified against all clusters and the “best” cluster is then updated. As used herein, new observations include observations from a device that is newly associated with a business as well as observations from a device that has moved from one spatially defined location to another. In this way, movement events can be created if the best cluster and previously assigned cluster were not one in the same, or if they were, then the prior-assigned cluster’s state can be further reinforced.

If lower-level classifiers be needed (like in determining which room a device is in) that can be nested within the hierarchy of the clusters. In this way, the problem of room determination is broken down into bite-sized pieces; first determining the one cluster 902, 904, 906 or 908, which could be as many as 25 to 50 physical offices, and then determining the one room in an office, which could be 10 to 40, for example. This is a simpler problem that trying to determine a room alone, which could include sorting through 250 to 5000 rooms.

It is desired to measure/predict the inclusion of an observation in a larger set of measurements, within which stray or transient observations often come and go. An example of this may consist of, but is not limited to, wireless signals emitters within offices. Here, Bluetooth, WiFi, or other radio transmitters may be present, and the observation of these emitters may uniquely identify one spatially defined location over another. Some of these emitters may be part of the building/office infrastructure and are relatively stable in their presence, whereas others, particularly those being worn or carried by persons, may be transient and intermittently seen. Worse, some of these mobile emitters may be from passersby external to the office space and thus may only be encountered in one or a handful of measurement sets. Still worse, other mobile emitters may be from traveling office personal who are in Office-A during some times and in Office-B at others. Here, the observation of emitters carried by these persons can confuse most types of classifier and lead to non-unique or low confidence predictions. A means to robustly adapt to changing and highly variable environments is desired.

Bloom Filters are a robust, and highly efficient way at predicting inclusion of an element within a larger set. These offer completely accurate determination of an element’s absence from the set and can be tuned to give a low and fixed probability of false-positive for presence within the set.

A variation of the common Bloom Filter that allows for elements to come and go from the set is the Counting Bloom Filter, or, more specifically for this problem, the Counting Down Bloom Filter. Here, each element is “added to the filter” (the actual addition of elements to the filter is slightly more involved than this would imply) with an initial non-zero count. Upon subsequent addition of other elements, the counts for all currently included elements is decremented until, at some point, an element’s count is zero and it is no longer in the filter. In this way, all elements in the filter have a “lifetime” after which, and if they have not been observed again, they will be automatically removed.

This Counting Down Bloom Filter works extremely well for the problem of transient elements and is quite robust for predicting inclusion of emitters within spaces. Still, it suffers from a problem when trying to make comparisons between several such filters for trying to identify one more likely set over the other as it cannot account for the general amount of variability that may be present within the sets. As an illustration of this consider two offices: Office-A is in an isolated building in the country and has a regular set of employees present. This type of office may correspond to cluster 908, for example. Alternatively, Office-B resides in a major metropolitan city, such as cluster 902, and is housed in a large building shared by many other organizations. At Office-A any measurement scan (of wireless emitters) may regularly observe 90% of all emitters consistently whereas at Office-B perhaps only 10% of emitters are commonly seen from scan to scan. Now, if a team or group of employees travels from Office-A to Office-B for a meeting it is likely that any scan during this time would observe a number of Office-A’s elements temporarily in Office-B. As such, the Office-A filter would observe these contained elements (as well as many non-contained ones) whereas the Office-B filter would generally only observe the same characteristic 10% of known elements. It is then possible that the raw count of elements from Office-A would exceed that from the Office-B’s filter and thus a predictor may misclassify the sample as having been taken at Office-A. Here, the problem stems from the fact that relative occurrence rate of “valid” elements in each filter (90% for Office-A and only 10% for Office-B) was not taken into account and that while there were still a large number of Office-A emitters observed, the relative percentage did not match what was typical.

A method to measure/predict the variability in sets of measurements and in determine their relative probability of “expression” of a given set. A Bloom Filter is used to track elements from a noisy and evolving set. At any instant, some sampling of that set is preformed, and the question posed as to how well that sampling represents the set. A means of tracking the amount of random “junk” in the samples may be used that to scale the probabilities accordingly. Sets that are traditionally very noisy only require a few samples to be in the filter in order to achieve a high score, whereas sets that are traditionally very stable require much more. This is to say, the method measures the variability in samples and uses that in predicting inclusion; stable sets need more matches whereas noisy ones do not.

This is done by tracking the average percentage of inclusion in the samples and then scaling the scoring accordingly.

Consider a measurement set, M, made up of some number, nᵥ, “valid” elements, {E_{v_i}}, and another number, nⱼ, of “junk” or transient elements, {E_{j_i}}:

$$M = \left\{{E}_{{v}_{o}} , {E}_{{v}_{1}} , {E}_{{v}_{2}} , ⋯ , {E}_{{v}_{{n}_{v}}} , {E}_{{j}_{0}} , {E}_{{j}_{1}} , {E}_{{j}_{2}} , ⋯ , {E}_{{j}_{{n}_{j}}}\right\} , \left({n}_{v} , {n}_{j}\right) ∈ {ℤ}^{+}$$

To approximate the probability that this measurement was made at a given location where the valid elements are usually present, the general or Counting Down Bloom Filter, F, would simply count the number of elements found in the filter and normalize by the total number of measured events to approximate the score:

$${s}_{0} \begin{matrix}= \frac{\left‖F ∩ M\right‖}{\left‖M\right‖} \\ = \frac{{n}_{v}}{{n}_{v} + {n}_{j}}\end{matrix}$$

It quickly becomes apparent though that at “noisy” locations (i.e., those characterized by many transient emitters and large nⱼ) this score will tend to decrease even if the number of matched valid emitters remains high.

Alternatively, assuming that the preferred result is “the probability that filter contains the measured events given that the measured events contain junk.“ Using Bayesian probability gives:

$$s \begin{matrix}= P \left(F ⊂ M \left|M ⊃ \left\{{E}_{j}\right\}\right)\right) \\ = \frac{P \left(F ⊂ M \& M ⊃ \left\{{E}_{j}\right\}\right)}{P \left(M ⊃ \left\{{E}_{j}\right\}\right)} ,\end{matrix}$$

where the numerator represents our raw filter score, s₀, so this is effectively just a normalization:

$$s = \frac{{s}_{0}}{P \left(M ⊃ \left\{{E}_{j}\right\}\right)}$$

The denominator is now in question and can be difficult to evaluate directly. Fortunately, this term can be considered as effectively representing “the average amount of ‘junk’ in the measurements” and so it can be approximated via other means. A sufficient estimator for the amount of junk in a measurement is simply the mean filter-score of past measurements. Thus:

$$s ≅ \frac{{s}_{0}}{\left〈{s}_{0}\right〉}$$

Programmatically, this average can be computed by some type of rolling-average or an exponential-average offers a convenient means with very little memory or computation overhead.

Finally, it should be noted that this approach can lead to scores greater than one when s₀ > 〈s₀〉. Since it should represent a pseudo-probability this is non-ideal. One resolution is to “clamp” the score at 1:

$$s ≅ \left\{\begin{matrix}\frac{{s}_{0}}{\left〈{s}_{0}\right〉} & , & {s}_{0} < \left〈{s}_{0}\right〉 \\ 1 & , & e l s e\end{matrix}\right)$$

For scoring and comparison this is not sufficient because, for example, if s₀ is 90% for one filter and 100% for another (and 〈s₀〉 were 50% in each) then the resolved scores would each both be one and the fact that one filter was a better match than the other will have been lost. Instead, modified piecewise function can address this:

$$s ≅ \left\{\begin{matrix}\frac{p ⋅ {s}_{0}}{\left〈{s}_{0}\right〉} & , & {s}_{0} < \left〈{s}_{0}\right〉 \\ \frac{\left(1 - p\right) \left({s}_{0} - \left〈{s}_{0}\right〉\right)}{1 - \left〈{s}_{0}\right〉} + p & , & e l s e\end{matrix}\right)$$

Where p ∈ [0, 1] and is the transition score. A final score of s = 1 is obtained only when all elements of M are in F, but if the expected number of elements are found, then s = p.

The filter (a Counting Down Bloom Filter) in constructed and initialized to contain all zero counts. An additional parameter, the mean_score, is defined and initialized to one and a constant parameter α, is set to a desired decimal value in the range 0 to 1.

Each time a measurement set, M, is to be added to the given filter F the method:
1. Compute the raw _score according to:
$$\text{raw\_score = count} \left(M \text{in F}\right)$$
2. Update the mean_score as an exponential average:
$$\text{mean\_score =} α \text{* mean\_score +} \left(1 - α\right) \text{* raw\_score}$$
3. Deprecate all non-zero counts in the filter by 1
4. Insert the elements of M into the filter by computing their respective hash indices. At each index we set the filter’s value to some max_count.

Each time a measure of a set M’s score in the filter is taken (other than when adding it) the method:
1. Compute the raw_score according to:
$$\text{raw\_score = count} \left(M \text{in} F\right) ;$$
2. Compute and return the actual_score as:
$$\begin{matrix}\text{if raw\_score <= mean\_score} \\ \text{actual\_score = p *} \text{raw\_score} / \text{mean\_score}\end{matrix}$$
else
$$\begin{matrix}\text{actual\_score =} \left(1 - \text{p}\right) * \left(\text{raw\_score} - \text{mean\_score}\right) / \left(1\right) \\ - \left(\text{mean\_score}\right) + \text{p}\end{matrix}$$

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A computer-implemented method of clustering devices according to spatially defined locations, comprising:
receiving a plurality of observations of measurable metrics from the devices;
scoring the plurality of observations to define a cluster state at each of the spatially defined locations, wherein the cluster state comprises a plurality of measurable quantities;
assigning the devices to a cluster of a plurality of clusters;
after assigning the devices to the cluster, receiving additional observations of measurable metrics from the devices; and
autonomously updating the cluster states in based on the additional observations.

2. The computer-implemented method of claim 1, wherein scoring the plurality of observations further comprises evaluating the observations for consistency with the cluster state.

3. The computer-implemented method of claim 1, wherein a first observation of the plurality of observations comprises a location of a device making the first observation and scoring the first observation further comprises:
calculating an uncertainty ellipsoid of the location;
integrating the uncertainty ellipsoid through bounds of the spatially defined location of a cluster; and
determining a probability of inclusion of the device making the first observation in one or more clusters of the plurality of clusters.

4. The computer-implemented method of claim 1, wherein a second observation of the plurality of observations comprises a wireless signals fingerprint of a device making the second observation and scoring the second observation further comprises:
using a Bloom filter to count a number of emitters in the wireless signals fingerprint.

5. The computer-implemented method of claim 4, wherein the Bloom filter further comprises a Counting Down Bloom Filter, F, initialized to contain all zero counts and adding a measurement set, M, to F comprises:
computing a raw_score = count(M in F);
updating a mean_score as an exponential average wherein mean_score = α * mean_score + (1 - α) * raw_score;
deprecating all non-zero counts in the filter by 1; and
inserting the elements of M into F by computing their respective hash indices and setting the value of F(index) to max_count;
wherein M is a measurement set, mean_score is initialized to 1, α is set to a desired decimal value between 0 and 1 and max_count.

6. The computer-implemented method of claim 5, wherein determining the score of a measurement set M in F comprises:
computing the raw_score = count(M in F);
computing and returning an actual_score as:
if raw_score <= mean_score then actual_score = p * raw_score/mean_score else actual_score = (1 - p)*(raw_score - mean_score)/ (1 - mean_score) + p; where p ∈ [0, 1] and is a transition score.

7. The computer-implemented method of claim 1, wherein the measurable metric comprises an atmospheric condition.

8. The computer-implemented method of claim 1, wherein the measurable metric comprises acoustic wave signatures.

9. The computer-implemented method of claim 1, wherein each observation further comprises a set of measurable metrics and scoring an observation against a cluster state yields a vector of scores for each measurable metric.

10. The computer-implemented method of claim 9, wherein a number of measurable metrics in an observation is less than the number of measurable metrics in the cluster state.

11. The computer-implemented method of claim 9, wherein a neural network classifier is trained to reduce the vector of scores to assign a device associated with an observation to the spatially defined location associated with a highest scoring cluster state.

12. A system comprising processing circuitry for clustering devices according to spatially defined locations, the processing circuitry performing a method of:
receiving a plurality of observations of measurable metrics from the devices;
scoring the plurality of observations to define a cluster state at each of the spatially defined locations, wherein the cluster state comprises a plurality of measurable quantities;
assign the devices to a cluster of a plurality of clusters;
after assigning the devices to the cluster, receive additional observations of measurable metrics from the devices; and
autonomously update the cluster states in based on the additional observations.

13. The system of claim 12, wherein scoring the plurality of observations further comprises evaluating the observations for consistency with the cluster state.

14. The system of claim 12, wherein a first observation of the plurality of observations comprises a location of a device making the first observation and scoring the first observation further comprises:
calculating an uncertainty ellipsoid of the location;
integrating the uncertainty ellipsoid through bounds of the spatially defined location of a cluster; and
determining a probability of inclusion of the device making the first observation in one or more clusters of the plurality of clusters.

15. The system of claim 12, wherein a second observation of the plurality of observations comprises a wireless signals fingerprint of a device making the second observation and scoring the second observation further comprises:
using a Bloom filter to count a number of emitters in the wireless signals fingerprint.

16. The system of claim 15, wherein the Bloom filter further comprises a Counting Down Bloom Filter, F, initialized to contain all zero counts and adding a measurement set, M, to F comprises:
computing a raw_score = count(M in F);
updating a mean_score as an exponential average wherein mean_score = α * mean_score + (1 - α) * raw_score;
deprecating all non-zero counts in the filter by 1; and
inserting the elements of M into F by computing their respective hash indices and setting the value of F(index) to max_count;
wherein M is a measurement set, mean_score is initialized to 1, α is set to a desired decimal value between 0 and 1 and max_count.

17. The system of claim 16, wherein determining the score of a measurement set M in F comprises:
computing the raw_score = count(M in F);
computing and returning an actual_score as:
if raw_score <= mean_score then actual_score = p * raw_score/mean_score else actual_score = (1 - p)*(raw_score - mean_score)/ (1 - mean_score) + p; where p ∈ [0, 1] and is a transition score.

18. The system of claim 12, wherein each observation further comprises a set of measurable metrics and scoring an observation against a cluster state yields a vector of scores for each measurable metric.

19. The system of claim 18, wherein a number of measurable metrics in an observation is less than the number of measurable metrics in the cluster state.

20. The system of claim 18, wherein a neural network classifier is trained to reduce the vector of scores to assign a device associated with an observation to the spatially defined location associated with a highest scoring cluster state.
